(19) United States
(12) Patent Application Publication
(10) Pub. No.: US 2005/0219453 A1
(43) Pub. Date: Oct. 6, 2005

(54) Liquid crystal, display device, driving method therefor and electronic equipment

(75) Inventors: Masumi Kubo, Ikoma-shi (JP); Hisakazu Nakamura, Yamatokoriyama-shi (JP); Hiroyuki Ohgami, Shiki-gun (JP); Akihiro Yamamoto, Yamatokoriyama-shi (JP); Tadashi Kawamura, Tenri-shi (JP); Takashi Ochi, Tenri-shi (JP); Yohichi Naruse, Tenri-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/092,948

(22) Filed: Mar. 30, 2005

(30) Foreign Application Priority Data
Mar. 31, 2004 (JP) 2004-108421

(51) Int. Cl. G02F 1/1343

(52) U.S. Cl. 349/143; 349/139

(57) ABSTRACT

The liquid crystal display device of the invention includes a plurality of pixels each having a first electrode, a second electrode facing the first electrode, and a vertically aligned liquid crystal layer placed between the first and second electrodes. The device further includes stripe-shaped first alignment regulating means having a first width placed in the first electrode side of the liquid crystal layer; stripe-shaped second alignment regulating means having a second width placed in the second electrode side of the liquid crystal layer; and a stripe-shaped liquid crystal region having a third width defined between the first and second regulating means. The third width is in a range between 2 μm and 15 μm.

### BACKGROUND OF THE INVENTION

1. Field of the Invention

The present invention relates to a liquid crystal display device and a driving method for the same, and more particularly relates to a liquid crystal display device suitably used for display of moving images, a driving method for the same, and electronic equipment provided with such a liquid crystal display device.

2. Description of the Related Art

In recent years, liquid crystal display devices (LCDs) have increasingly come into widespread use. Among various types of LCDs, mainstream has been a TN LCD in which a nematic liquid crystal material having positive dielectric anisotropy is twisted. The TN LCD however has a problem of being large in visual angle dependence that results from the alignment of liquid crystal molecules.

To improve the visual angle dependence, alignment-divided vertical alignment LCDs have been developed, and use of these LCDs is expanding. For example, Japanese Patent Gazette No. 2947350 (Literature 1) discloses a multi-domain vertical alignment (MVA) LCD as one of the alignment-divided vertical alignment LCDs. The MVA LCD, which includes a vertically aligned liquid crystal layer placed between a pair of electrodes to present display in the normally black (NB) mode, is provided with domain regulating means (for example, slits or protrusions) to enable liquid crystal molecules in each pixel to fall (tilt) in a plurality of different directions during application of a voltage.

Recently, needs for displaying moving image information have rapidly increased, not only in LCD TVs, but also in PC monitors and portable terminal equipment (such as mobile phones and PDAs). To display moving images with high quality on LCDs, it is necessary to shorten the response time (increase the response speed) of the liquid crystal layer, so that a predetermined grayscale level can be reached within one vertical scanning period (typically, one frame).

As a driving method that can improve the response characteristic of LCDs, known is a method in which a voltage higher than a voltage (grayscale voltage) corresponding to the grayscale level to be displayed (this voltage is called an “overshoot (OS) voltage”) is applied (this method is called “overshoot (OS) driving”). With application of an OS voltage, the response characteristic in grayscale display can be improved. For example, Japanese Laid-Open Patent Publication No. 2000-231091 (Literature 2) discloses an MVA LCD adopting the OS driving.

The response speed of the liquid crystal layer is lower as the applied voltage is lower. Therefore, it has conventionally been presumed that good moving image display will be obtained by only improving the response speed at the application of a low voltage (for example, at a shift from the black display state to a low-luminance grayscale display state) using the OS driving.

However, the inventors of the present invention have found that in alignment-divided vertical alignment LCDs such as the MVA LCDs described above, liquid crystal molecules in the liquid crystal layer exhibit a unique behavior when the applied voltage is high (for example, when a shift is made from the black display state to a high-luminance grayscale display state or the white display state), resulting in decrease in response speed. This decrease in response speed due to this phenomenon found by the present inventors is not improved with the OS driving and causes degradation in display quality.

The present inventors have examined the above phenomenon in various ways and found that this phenomenon is a new problem that has never occurred as long as the OS driving is adopted for conventional TN LCDs, and results from the alignment division done with alignment regulating means (domain regulating means) placed linearly (in a stripe shape) in each pixel in alignment-divided vertical alignment LCDs.

### SUMMARY OF THE INVENTION

In view of the above, a main object of the present invention is providing an alignment-divided vertical alignment LCD permitting high quality moving image display, a driving method therefor, and electronic equipment provided with such an LCD.

The liquid crystal display device of the present invention includes has a plurality of pixels each having a first electrode, a second electrode facing the first electrode, and a vertically aligned liquid crystal layer placed between the first and second electrodes, the device including: a stripe-shaped rib having a first width placed in the first electrode side of the liquid crystal layer; a stripe-shaped slit having a second width placed in the second electrode side of the liquid crystal layer; and a stripe-shaped liquid crystal region having a third width defined between the rib and the slit, wherein the third width is in a range between 2 μm and 15 μm.

In a preferred embodiment, the third width is 13.5 μm or less.

In a preferred embodiment, the device further includes a pair of polarizing plates placed to face each other with the liquid crystal layer therebetween, transmission axes of the pair of polarizing plates are orthogonal to each other, one of the transmission axes extends in a horizontal direction in the display plane, and the rib and the slit are placed to extend in a direction about 45° from the one of the transmission axes.

In a preferred embodiment, the magnitude of the voltage corresponding to the highest grayscale level is 7V or more.

In a preferred embodiment, the magnitude of the voltage corresponding to the lowest grayscale level is 0.5V or less.

Alternatively, the liquid crystal display device of the present invention has a plurality of pixels each having a first electrode, a second electrode facing the first electrode, and a vertically aligned liquid crystal layer placed between the first and second electrodes, the device including: a stripe-shaped first slit having a first width placed in the first electrode; a stripe-shaped second slit having a second width placed in the second electrode; and a stripe-shaped liquid crystal region having a third width defined between the first and second slits, wherein the third width is in a range between 2 μm and 15 μm.

In a preferred embodiment, the third width is 14.2 μm or less.

In a preferred embodiment, the device further includes a pair of polarizing plates placed to face each other with the liquid crystal layer therebetween, transmission axes of the pair of polarizing plates are orthogonal to each other, one of the transmission axes extends in a horizontal direction in the display plane, and the first and second slits are formed to extend in a direction about 45° from the one of the transmission axes.

In a preferred embodiment, the magnitude of the voltage corresponding to the highest grayscale level is 7V or more.

In a preferred embodiment, the magnitude of the voltage corresponding to the lowest grayscale level is 1.6V or less.

Alternatively, the liquid crystal display device of the present invention has a plurality of pixels each having a first electrode, a second electrode facing the first electrode, and a vertically aligned liquid crystal layer placed between the first and second electrodes, the device including: stripe-shaped first alignment regulating means having a first width placed in the first electrode side of the liquid crystal layer; stripe-shaped second alignment regulating means having a second width placed in the second electrode side of the liquid crystal layer; and a stripe-shaped liquid crystal region having a third width defined between the first and second alignment regulating means, wherein the third width is in a range between 2 μm and 15 μm.

Alternatively, the liquid crystal display device of the present invention includes a liquid crystal panel having a plurality of pixels each having a first electrode, a second electrode facing the first electrode, and a vertically aligned liquid crystal layer placed between the first and second electrodes, the device including: stripe-shaped first alignment regulating means having a first width placed in the first electrode side of the liquid crystal layer; stripe-shaped second alignment regulating means having a second width placed in the second electrode side of the liquid crystal layer; and a stripe-shaped liquid crystal region having a third width defined between the first and second alignment regulating means, wherein the liquid crystal region has a first liquid crystal portion adjacent to the first alignment regulating means, a second liquid crystal portion adjacent to the second alignment regulating means, and a third liquid crystal portion defined between the first and second liquid crystal portions, the third liquid crystal portion having a response speed lower than the response speeds of the first and second liquid crystal portions, and the third width is set at a predetermined value or less so that the transmittance obtained when the time corresponding to one vertical scanning period has passed after application of a voltage corresponding to the highest grayscale level in the black display state can be 75% or more of the transmittance in the highest grayscale display state at a panel temperature of 5° C.

In a preferred embodiment, the first alignment regulating means is a rib and the second alignment regulating means is a slit formed in the second electrode.

In a preferred embodiment, the first alignment regulating means is a slit formed in the first electrode and the second alignment regulating means is a slit formed in the second electrode.

In a preferred embodiment, the device further includes a pair of polarizing plates placed to face each other with the liquid crystal layer therebetween, transmission axes of the pair of polarizing plates are orthogonal to each other, one of the transmission axes extends in a horizontal direction in the display plane, and the first and second alignment regulating means are placed to extend in a direction about 45° from the one of the transmission axes.

In a preferred embodiment, the first width is in a range between 4 μm and 20 μm, and the second width is in a range between 4 μm and 20 μm.

In a preferred embodiment, the thickness of the liquid crystal layer is 3.2 μm or less.

In a preferred embodiment, the first electrode is a counter electrode, and the second electrode is a pixel electrode.

In a preferred embodiment, the device further includes a drive circuit capable of applying an overshoot voltage higher than a grayscale voltage predetermined for a given grayscale level in grayscale display.

The driving method for a liquid crystal display device of the present invention is a driving method for the liquid crystal display device described above, including the step of applying an overshoot voltage higher than a grayscale voltage predetermined for a given grayscale level in display of the given grayscale level, the given grayscale level being higher than a grayscale level displayed in the preceding vertical scanning period.

In a preferred embodiment, the overshoot voltage is set so that the display luminance reaches a given luminance value for the given grayscale level within a time corresponding to one vertical scanning period.

The electronic equipment of the present invention includes the liquid crystal display device described above.

In a preferred embodiment, the equipment further includes a circuit for receiving television broadcast.

According to the present invention, the width of the liquid crystal regions is set to fall in a predetermined range, so that occurrence of a unique behavior (“alignment deflection” to be described later) of liquid crystal molecules in an alignment-divided vertically aligned LCD can be suppressed. Hence, the response characteristic is improved and the quality of moving image display can be enhanced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1A, 1B and 1C are cross-sectional views diagrammatically showing basic constructions of MVA LCDs of embodiments of the present invention.

FIG. 2 is a partial cross-sectional view diagrammatically showing the sectional structure of an LCD 100 of an embodiment of the present invention.

FIG. 3 is a diagrammatic plan view of a pixel portion 100a of the LCD 100.

FIG. 4A is a graph showing a change of the intensity of transmitted light in the LCD 100 with time observed when a shift is made from the black display state to the white display state, and FIG. 4B shows continuous photos of a pixel portion of the LCD 100 taken at the shift from the black display state to the white display state with a high-speed camera.

FIG. 5A is a graph showing a change of the intensity of transmitted light in the LCD 100 with time observed when a shift is made from the black display state to the white display state, and FIG. 5B shows continuous photos of a pixel portion of the LCD 100 taken at the shift from the black display state to the white display state with a high-speed camera.

FIG. 6A is a graph showing a change of the intensity of transmitted light in the LCD 100 with time observed when a shift is made from the black display state to the white display state, and FIG. 6B shows continuous photos of a pixel portion of the LCD 100 taken at the shift from the black display state to the white display state with a high-speed camera.

FIG. 7A is a graph showing a change of the intensity of transmitted light in the LCD 100 with time observed when a shift is made from the black display state to the white display state, and FIG. 7B shows continuous photos of a pixel portion of the LCD 100 taken at the shift from the black display state to the white display state with a high-speed camera.

FIGS. 8A to 8C are graphs showing the results of measurement of the response time (ms) with varying LC region widths W3 (μm).

FIGS. 9A to 9C are graphs showing the results of measurement of the response time (ms) with varying LC region widths W3 (μm).

FIGS. 10A to 10C are graphs showing the results of measurement of the response time (ms) with varying rib deviation amounts (μm).

FIGS. 11A to 11C are graphs showing the results of measurement of the response time (ms) with varying rib deviation amounts (μm).

FIGS. 12A to 12C are graphs showing the results of measurement of the response time (ms) with varying Δε (dielectric anisotropy) values of the liquid crystal material.

FIGS. 13A to 13C are graphs showing the results of measurement of the response time (ms) with varying thicknesses (μm) of the liquid crystal layer.

FIGS. 14A to 14C are graphs showing the results of measurement of the response time (ms) with varying rib widths W1 (μm).

FIGS. 15A to 15C are graphs showing the results of measurement of the response time (ms) with varying rib heights (μm).

FIGS. 16A to 16C are graphs showing the results of measurement of the response time (ms) with varying slit widths W2 (μm).

FIGS. 17A to 17C are graphs showing the results of measurement of the grayscale attainment rate (%) with varying LC region widths W3 (μm).

FIGS. 18A to 18C are graphs showing the results of measurement of the grayscale attainment rate (%) with varying LC region widths W3 (μm).

FIG. 19 is a graph showing the relationship between the target grayscale level and the OS grayscale level given when a shift is made from level 0 to a predetermined target grayscale level.

FIG. 20A is a graph showing a change of the intensity of transmitted light in the LCD 100 with time observed when a shift is made from the black display state to the white display state, and FIG. 20B shows continuous photos of a pixel portion of the LCD 100 taken at the shift from the black display state to the white display state with a high-speed camera.

FIG. 21A is a graph showing a change of the intensity of transmitted light in the LCD 100 with time observed when a shift is made from the black display state to the white display state, and FIG. 21B shows continuous photos of a pixel portion of the LCD 100 taken at the shift from the black display state to the white display state with a high-speed camera.

FIG. 22A is a graph showing a change of the intensity of transmitted light in the LCD 100 with time observed when a shift is made from the black display state to the white display state, and FIG. 22B shows continuous photos of a pixel portion of the LCD 100 taken at the shift from the black display state to the white display state with a high-speed camera.

FIG. 23A is a graph showing a change of the intensity of transmitted light in the LCD 100 with time observed when a shift is made from the black display state to the white display state, and FIG. 23B shows continuous photos of a pixel portion of the LCD 100 taken at the shift from the black display state to the white display state with a high-speed camera.

FIG. 24 is a view diagrammatically showing the alignment of liquid crystal molecules 13a in a portion of a liquid crystal region 13A near a slit 22.

FIGS. 25A and 25B are diagrammatic views for demonstrating the influence of an interlayer insulating film of an LCD on the alignment of liquid crystal molecules.

FIGS. 26A to 26C are graphs showing the results of measurement of the grayscale attainment rate (%) with varying rib deviation amounts (μm).

FIGS. 27A to 27C are graphs showing the results of measurement of the grayscale attainment rate (%) with varying rib deviation amounts (μm).

FIG. 28 is a partial cross-sectional view diagrammatically showing the sectional structure of an LCD 200 of another embodiment of the present invention.

FIG. 29 is a diagrammatic plan view of a pixel portion 200a of the LCD 200.

FIGS. 30A to 30C are graphs showing the results of measurement of the response time (ms) with varying LC region widths W3 (μm).

FIGS. 31A to 31C are graphs showing the results of measurement of the response time (ms) with varying LC region widths W3 (μm).

FIGS. 32A to 32C are graphs showing the results of measurement of the response time (ms) with varying thicknesses (μm) of the liquid crystal layer.

FIGS. 33A to 33C are graphs showing the results of measurement of the response time (ms) with varying slit widths W1 (μm) in a counter electrode 11.

FIGS. 34A to 34C are graphs showing the results of measurement of the response time (ms) with varying slit widths W2 (μm) in a pixel electrode 12.

FIGS. 35A to 35C are graphs showing the results of measurement of the grayscale attainment rate (%) with varying LC region widths W3 (μm).

FIGS. 36A to 36C are graphs showing the results of measurement of the grayscale attainment rate (%) with varying LC region widths W3 (μm).

FIGS. 37A to 37C are graphs showing the results of measurement of the grayscale attainment rate (%) with varying thicknesses d (μm) of the liquid crystal layer.

FIGS. 38A to 38C are graphs showing the results of measurement of the grayscale attainment rate (%) with varying slit widths W1 (μm) in the counter electrode 11.

FIGS. 39A to 39C are graphs showing the results of measurement of the grayscale attainment rate (%) with varying slit widths W2 (μm) in the pixel electrode 12.

FIG. 40 is a plan view diagrammatically showing a pixel portion 300a of an LCD of yet another embodiment of the present invention.

### DETAILED DESCRIPTION OF PREFERRED EMBODIMENTS

Hereinafter, LCDs of embodiments of the present invention and driving methods for the LCDs will be described with reference to the relevant drawings.

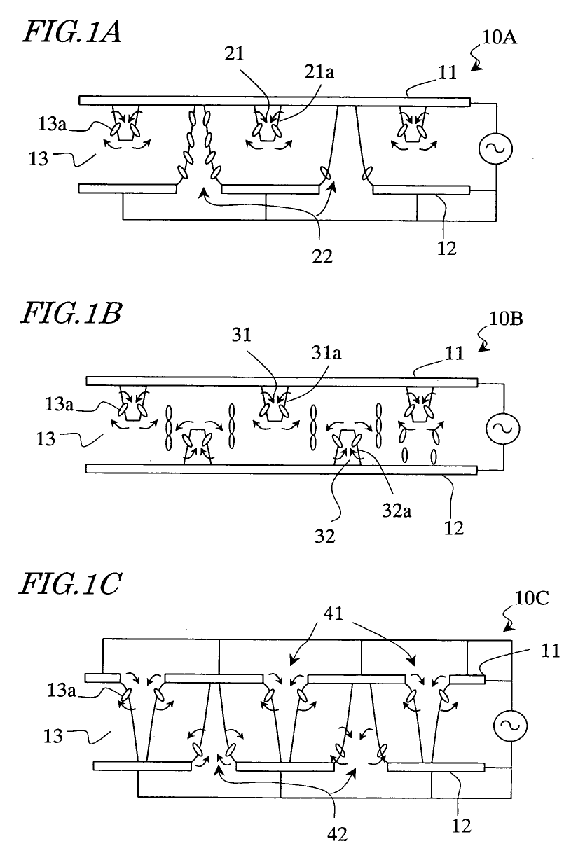

First, basic constructions of alignment-divided vertical alignment LCDs of embodiments of the present invention will be described with reference to FIGS. 1A to 1C.

Alignment-divided vertical alignment LCDs 10A, 10B and 10C include a plurality of pixels each having a first electrode 11, a second electrode 12 facing the first electrode 11, and a vertical alignment liquid crystal layer 13 placed between the first electrode 11 and the second electrode 12. The vertical alignment liquid crystal layer 13 includes liquid crystal molecules having negative dielectric anisotropy that are aligned roughly vertical (for example, at an angle in the range between 87° and 90°) to the plane of the first and second electrodes 11 and 12 during non-voltage application. Typically, this alignment is attained by providing a vertical alignment film (not shown) on each of the surfaces of the first and second electrodes 11 and 12 facing the liquid crystal layer 13. In the case of providing ribs (protrusions) and the like as alignment regulating means, liquid crystal molecules are aligned roughly vertical to the surfaces of the ribs and the like facing the liquid crystal layer.

First alignment regulating means (21, 31, 41) are provided in the first electrode 11 side of the liquid crystal layer 13, while second alignment regulating means (22, 32, 42) are provided in the second electrode 12 side of the liquid crystal layer 13. In each of liquid crystal regions defined between the first and second alignment regulating means, liquid crystal molecules 13a are under alignment regulating force applied from the first and second alignment regulating means. Once a voltage is applied between the first and second electrodes 11 and 12, the liquid crystal molecules 13a fall (tilt) in the directions shown by the arrows in FIGS. 1A to 1C. That is, in each of the liquid crystal regions, liquid crystal molecules 13a fall in a uniform direction. Such liquid crystal regions therefore can be regarded as domains. As the alignment regulating means as used herein, the domain regulating means described in Literature 1 and 2 mentioned above may be adopted.

The first alignment regulating means and the second alignment regulating means (hereinafter, these may be collectively called “alignment regulating means” in some cases) are placed in a stripe shape in each pixel. FIGS. 1A to 1C are cross-sectional views taken along the direction orthogonal to the extension of the stripe-shaped alignment regulating means. Liquid crystal regions (domains) in which liquid crystal molecules 13a fall in directions different by 180° from each other are formed on both sides of each alignment regulating means.

Specifically, the LCD 10A shown in FIG. 1A has ribs 21 as the first alignment regulating means and slits (openings) 22 formed in the second electrode 12 as the second alignment regulating means. The ribs 21 and the slits 22 extend in a stripe shape. The ribs 21 serve to align liquid crystal molecules 13a roughly vertically with respect to the side faces of the ribs 21, so that the liquid crystal molecules 13a are aligned in a direction orthogonal to the extension of the ribs 21. The slits 22 serve to generate a tilt electric field in areas of the liquid crystal layer 13 near the edges of the slits 22 when a potential difference is given between the first and second electrodes 11 and 12, so that the liquid crystal molecules 13a are aligned in a direction orthogonal to the extension of the slits 22. The ribs 21 and the slits 22 are placed in parallel with each other with a predetermined spacing therebetween, and liquid crystal regions (domains) are formed between the ribs 21 and the slits 22 adjacent to each other.

The LCD 10B shown in FIG. 1B is different from the LCD 10A shown in FIG. 1A in that ribs 31 and 32 are provided as the first and second alignment regulating means, respectively. The ribs 31 and 32 are placed in parallel with each other with a predetermined spacing therebetween, and serve to align liquid crystal molecules 13a to be roughly vertical to side faces 31a of the ribs 31 and side faces 32a of the ribs 32, to thereby form liquid crystal regions (domains) between these ribs.

The LCD 10C shown in FIG. 1C is different from the LCD 10A shown in FIG. 1A in that slits 41 and 42 are provided as the first and second alignment regulating means, respectively. The slits 41 and 42 serve to generate a tilt electric field in areas of the liquid crystal layer 13 near the edges of the slits 41 and 42 when a potential difference is given between the first and second electrodes 11 and 12, so that liquid crystal molecules 13a are aligned in a direction orthogonal to the extension of the slits 41 and 42. The slits 41 and 42 are placed in parallel with each other with a predetermined spacing therebetween, and liquid crystal regions (domains) are formed between these slits.

As described above, an arbitrary combination of ribs and/or slits can be used as the first and second alignment regulating means. The first and second electrodes 11 and 12 may be electrodes facing each other with the liquid crystal layer 13 therebetween. Typically, one electrode is a counter electrode, and the other is a pixel electrode. Hereinafter, an embodiment of the present invention will be described taking, as an example, an LCD having a counter electrode as the first electrode 11, a pixel electrode as the second electrode 12, ribs 21 as the first alignment regulating means, and slits 22 formed in the pixel electrode as the second alignment regulating means (that is, an LCD corresponding to the LCD 10A in FIG. 1A). The construction of the LCD 10A shown in FIG. 1A is advantageous in that increase in the number of fabrication steps can be minimized. That is, no additional step is required in forming slits in the pixel electrode. As for the counter electrode, increase in the number of steps is smaller in placing ribs thereon than in forming slits therein. Naturally, the present invention is also applicable to other constructions using only ribs and only slits as the alignment regulating means.

The present inventors have found from various examinations that the problem described above of the response speed at a shift from the black display state to a high-luminance grayscale display state being insufficient is caused by the alignment division done with the first and second alignment regulating means placed in pixels in a stripe shape, and that occurrence of this problem can be suppressed by limiting the width of liquid crystal regions defined between the first and second alignment regulating means to a predetermined range (more specifically, 15 μm or less). Hereinafter, the cause of this problem and effects of the LCD of the present invention will be described in detail. Hereinafter, the cause of this problem and the effect of the LCD of the present invention will be described in detail.

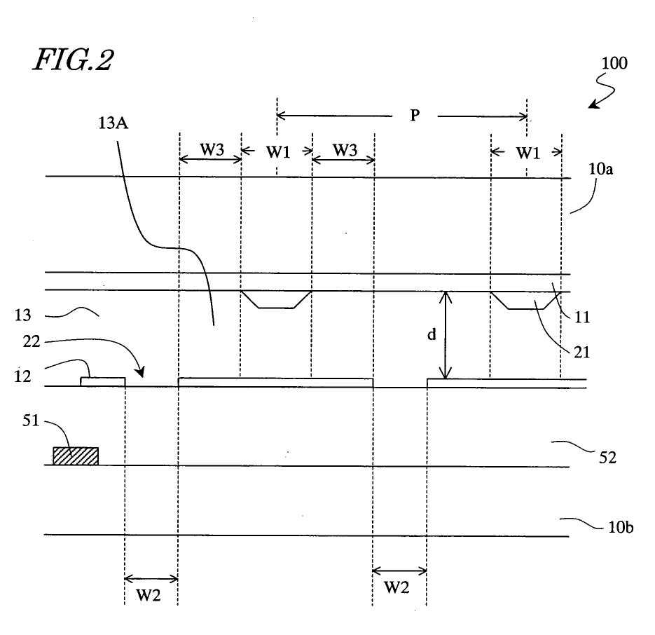

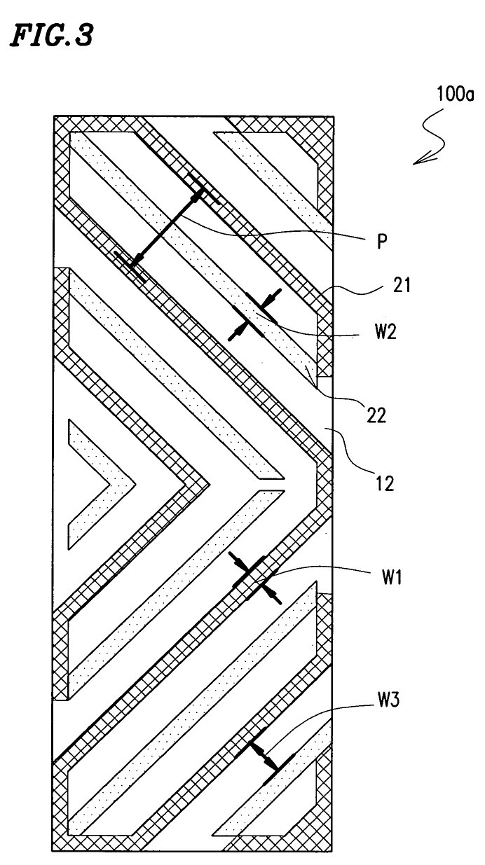

First, the basic construction of the LCD of the embodiment of the present invention will be described with reference to FIGS. 2 and 3. FIG. 2 is a partial cross-sectional view diagrammatically showing the sectional structure of an LCD 100, and FIG. 3 is a plan view of a pixel portion 10a of the LCD 100. The LCD 100 is substantially the same in basic construction as the LCD 10A shown in FIG. 1. Common components are therefore denoted by the same reference numerals.

The LCD 100 has a vertically aligned liquid crystal layer 13 between a first substrate (for example, glass substrate) 10a and a second substrate (for example, glass substrate) 10b. A counter electrode 11 is formed on the surface of the first substrate 10a facing the liquid crystal layer 13, and ribs 21 are formed on the counter electrode 11. A vertical alignment film (not shown) is formed covering substantially the entire surface of the counter electrode 11 including the ribs 21 facing the liquid crystal layer 13. The ribs 21 extend in a stripe shape as shown in FIG. 3 so that the adjacent ribs 21 are in parallel with each other with a uniform spacing (pitch) P therebetween. The width W1 of the ribs 21 (width in the direction orthogonal to the extension) is also uniform.

Gate bus lines (scanning lines) and source bus lines (signal lines) 51, as well as TFTs (not shown), are formed on the surface of the second substrate 10b facing the liquid crystal layer 13, and an interlayer insulating film 52 is formed to cover these components. A pixel electrode 12 is formed on the interlayer insulating film 52. The interlayer insulating film 52, which has a flat surface, is made of a transparent resin film having a thickness in the range between 1.5 μm and 3.5 μm, to thereby enable overlap placement of the pixel electrode 12 with the gate bus lines and/or the source bus lines. This is advantageous in improving the aperture ratio.

Stripe-shaped slits 22 are formed in the pixel electrode 12, and a vertical alignment film (not shown) is formed covering substantially the entire surface of the pixel electrode 12 including the slits 22. As shown in FIG. 3, the slits 22 extend in a stripe shape in parallel with each other so as to roughly bisect the spacing between the adjacent ribs 21. The width W2 of the slits 22 (width in the direction orthogonal to the extension) is uniform. The shapes and arrangements of the slits and ribs described above may deviate from the respective design values in some cases due to a variation in fabrication process, misalignment in bonding of the substrates and the like. The above description does not exclude these deviations.

A stripe-shaped liquid crystal region 13A having a width W3 is defined between the adjacent stripe-shaped rib 21 and slit 22 extending in parallel with each other. In the liquid crystal region 13A, the alignment direction is regulated with the rib 21 and the slit 22 placed on both sides of the region. Such liquid crystal regions (domains) are formed on the opposite sides of each of the ribs 21 and the slits 22, in which liquid crystal molecules 13a tilt in the directions different by 180° from each other. As shown in FIG. 3, in the LCD 100, the ribs 21 and the slits 22 extend in two directions different by 90° from each other, and each pixel portion 10a has four types of liquid crystal regions 13A different in the alignment direction of liquid crystal molecules 13a by 90° from one another. Although the arrangement of the ribs 21 and the slits 22 is not limited to the example described above, this arrangement ensures good viewing angle characteristic.

A pair of polarizing plates (not shown) is placed on the outer surfaces of the first and second substrates 10a and 10b so that the transmission axes thereof are roughly orthogonal to each other (in the crossed-Nicols state). If the polarizing plates are placed so that the transmission axes thereof form 45° with the alignment directions of all the four types of liquid crystal layers 13A that are different by 90° from one another, a change in retardation with the liquid crystal regions 13A can be used most efficiently. That is, the polarizing plates should preferably be placed so that the transmission axes thereof form roughly 45° with the directions of extension of the ribs 21 and the slits 22. In display devices in which observation is often moved in a direction horizontal to the display plane, such as TVs, the transmission axis of one of the polarizing plates preferably extends in a horizontal direction in the display plane for suppression of the viewing angle dependence of the display quality.

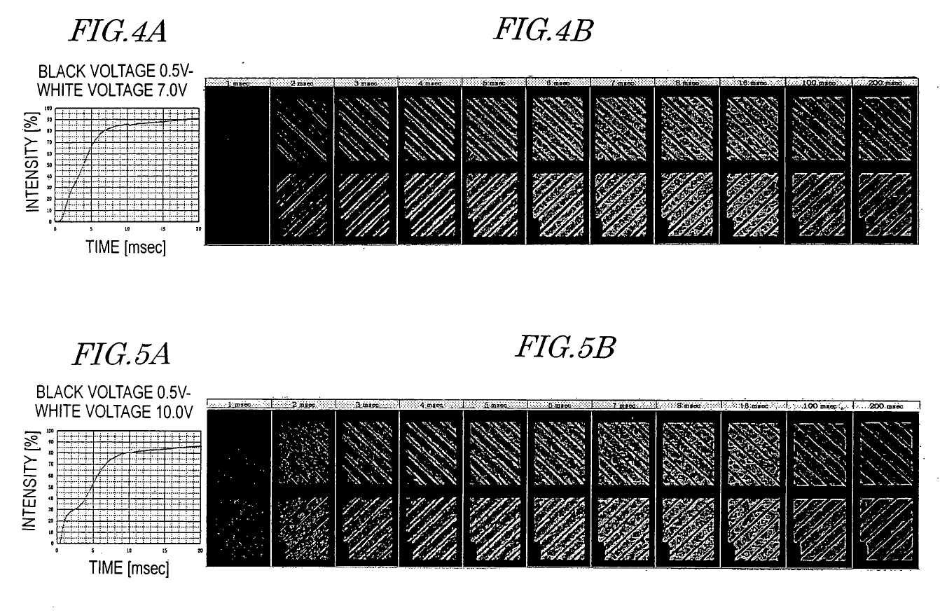

The MVA LCD 100 having the construction described above can present display excellent in viewing angle characteristic. However, liquid crystal molecules in the liquid crystal layer exhibit a unique behavior when a shift is made from the black display state to a high-voltage applied state (a high-luminance grayscale display state and the white display state), and this reduces the response speed. This phenomenon will be described in detain with reference to FIGS. 4A/B to 7A/B.

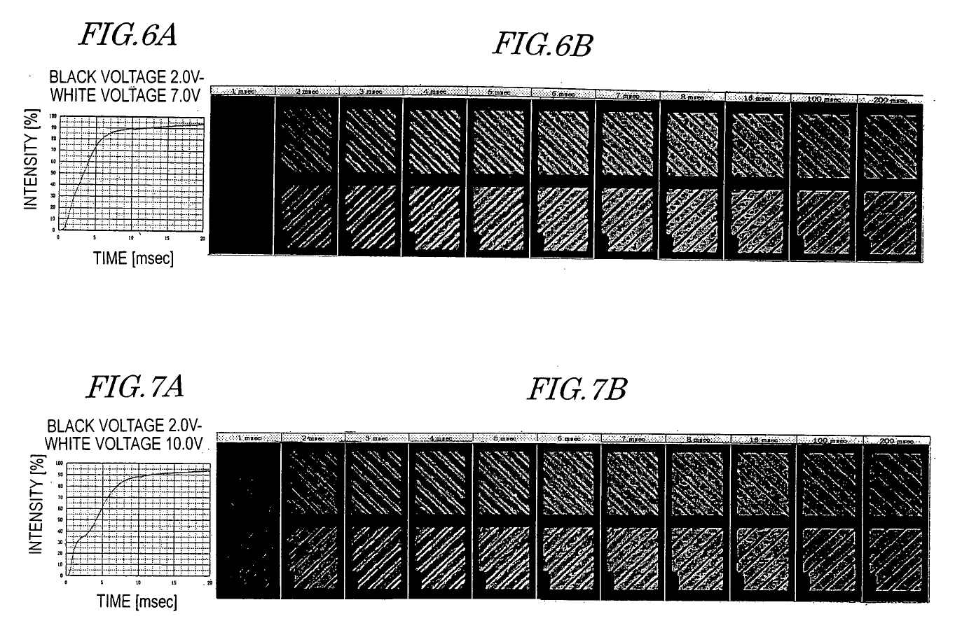

FIGS. 4A, 5A, 6A and 7A are graphs showing a change of the intensity of transmitted light with time observed when a shift is made from the black display state to the white display state. FIGS. 4B, 5B, 6B and 7B show continuous photos of a pixel portion taken at the shift from the black display state to the white display state with a high-speed camera. The y-axis of the graphs represents the intensity in percentage with respect to the intensity in the steady state after application of a white voltage as 100%. The specific parameters of the LCD 100 used in this examination are as shown in Table 1. The black voltage (V0) and the white voltage (V255) for the respective figures are as shown in Table 2.

TABLE 1

| | | | | | Measure- |
|---|---|---|---|---|---|
| Rib width | Slit width | LC region | Rib | Thickness d | ment |
| W1 | W2 | width W3 | height | of LC layer | temp. |
| 8 μm | 10 μm | 19 μm | 1.05 μm | 2.5 μm | 25° C. |

TABLE 2

| | |
|---|---|
| Black voltage | White voltage |

| | | | |
|---|---|---|---|
| 0.5 | V | 7 | V |
| 0.5 | V | 10 | V |
| 2 | V | 7 | V |
| 2 | V | 10 | V |

As is found from the continuous photos shown in FIGS. 4B, 5B, 6B and 7B, an alignment disturbance (tilt of liquid crystal molecules in random directions) occurs in the liquid crystal regions 13A immediately after voltage application. This phenomenon is called “alignment deflection” because the liquid crystal molecules 13a tilt in directions different from those to which the alignment is originally regulated. The alignment deflection is then gradually resolved, but is not completely resolved even after 16 msec as shown in the figures.

The alignment deflection occurs because each liquid crystal region 13A has two types of portions characterized by two different response speeds. The portions of the liquid crystal region 13A located near the rib 21 and the slit 22 (called “first LC portions R1”) are high in response speed because these are directly affected by the alignment regulating force of the rib 21 and the slit 22. On the contrary, the center portion of the liquid crystal region 13A (called a “second LC portion R2”) is lower in response speed than the first LC portions R1. During voltage application, therefore, the liquid crystal molecules 13a in the first LC portions R1 tilt in the direction regulated with the alignment regulation means, and thereafter, the liquid crystal molecules 13a in the second LC portion R2 tilt to agree with the alignment of the liquid crystal molecules 13a in the first LC portions R1. However, in the case of application of a high voltage, in which the torque for tilting the liquid crystal molecules 13a acts intensely, the liquid crystal molecules 13a in the second LC portion R2 are forced to tilt in random directions (determined with fine uneven surfaces of alignment films and the like) immediately after the voltage application. The liquid crystal molecules 13a tilting in random directions gradually change the alignment azimuth directions so as to agree with the alignment direction of the liquid crystal molecules 13a in the first LC regions R1.

In the above description, the alignment deflection was discussed using two types of LC portions for simplification. In the LCD 100 exemplified above, the degrees of the effect of the first alignment regulating means (rib 21) and the second alignment regulating means (slit 22) on the response speed are different from each other. Strictly, therefore, three LC portions different in response speed from one another are formed.

As described above, under application of a high voltage, the liquid crystal molecules 13a in the second LC portion R2 exhibit 2-stage response behavior in which they first fall with an electric field immediately after the voltage application (alignment deflection), and thereafter gradually change the alignment azimuth direction to secure continuity of the alignment. As a result, the response speed of the entire liquid crystal region 13A decreases.

As described above, the alignment deflection occurs in application of a high voltage. Hence, as is apparent from comparison between FIGS. 4A/B and 5A/B and between 6A/B and 7A/B, the occurrence of alignment deflection and the resultant decrease in response speed are more eminent as the white voltage is higher. This is the reason why the phenomenon that the response speed does not increase but rather decreases with increase of the white voltage may occur, against the general recognition that the response characteristic is improved with increase of the white voltage. Although the shift to the white display state was shown in these figures, the above description also applies to a shift to a high-luminance grayscale display state, in which the response speed will not be sufficiently increased even by adopting the OS driving.

Also, as is apparent from comparison between FIGS. 4A/B and 6A/B and between FIGS. 5A/B and 7A/B, the response speed is lower as the black voltage is lower. The reason is that as the black voltage is lower, the liquid crystal molecules 13a align closer to the vertical in the black display state. Contrarily, when the black voltage is high to allow the liquid crystal molecules 13a to tilt a little even in the black display state, the response speed increases. In this case, however, the contrast ratio will decrease due to the tilt of the liquid crystal molecules 13a. In recent years, a higher contrast ratio has been requested for LCDs, but if the contrast ratio is improved by decreasing the black voltage, the response speed will decrease as described above.

As described above, a higher white voltage and a lower black voltage result in decrease in response speed, and this decrease in response speed cannot be improved sufficiently even with the OS driving. Also, if the operating temperature of an LCD changes, the properties such as the viscosity of the liquid crystal material change, and as a result, the response characteristic of the LCD changes. The response characteristic degrades with decrease of the operating temperature, and improves with increase of the operating temperature. In the conventional alignment-divided vertical alignment LCDs, a sufficient response characteristic is unavailable at a panel temperature of 5° C.

The OS driving method is also applied to TN LCDs, but the alignment deflection described above is not observed in TN LCDs. The reason is that, in TN LCDs, the alignment division is made by regulating the alignment directions of liquid crystal molecules in respective liquid crystal regions (domains) with alignment films rubbed in different directions. Since the alignment regulating force is given to the entire of each liquid crystal region from a planar (two-dimensional) alignment film, no response speed distribution arises in each liquid crystal region. On the contrary, in alignment-divided vertical alignment LCDS, the alignment division is made with the linearly (one-dimensionally) provided alignment regulating means. Therefore, portions having different response speeds are formed with, not only the difference in the alignment regulating force of the alignment regulating means, but also the distance from the alignment regulating means.

For the purpose of preventing occurrence of the alignment deflection, MVA LCDs having the basic construction shown in FIGS. 2 and 3 were fabricated by varying the cell parameters (the thickness d of the liquid crystal layer, Δε (dielectric anisotropy) of the liquid crystal material, the rib width W1, the slit width W2, the LC region width W3, the rib height and the like), and the response characteristics of these devices were evaluated.

As a result, the following were found. The changes in response characteristic with changes of Δε of the liquid crystal material, the thickness d of the liquid crystal layer, the rib width W1, the rib height and the slit width W2 were minute, and thus the response speed improving effects obtained by adjusting these factors were all small. On the contrary, the response characteristic was greatly improved by narrowing the LC region width W3. Also, in actual LCDs, the positions of the ribs are sometimes deviated from the design positions due to a cause in the fabrication process (for example, misalignment in the step of bonding the substrates). In this relation, it was found that the response characteristic could be improved to some extent by reducing the degree of the deviation (called the “rib deviation amount”). Hereinafter, the results of the evaluation will be described in detail.

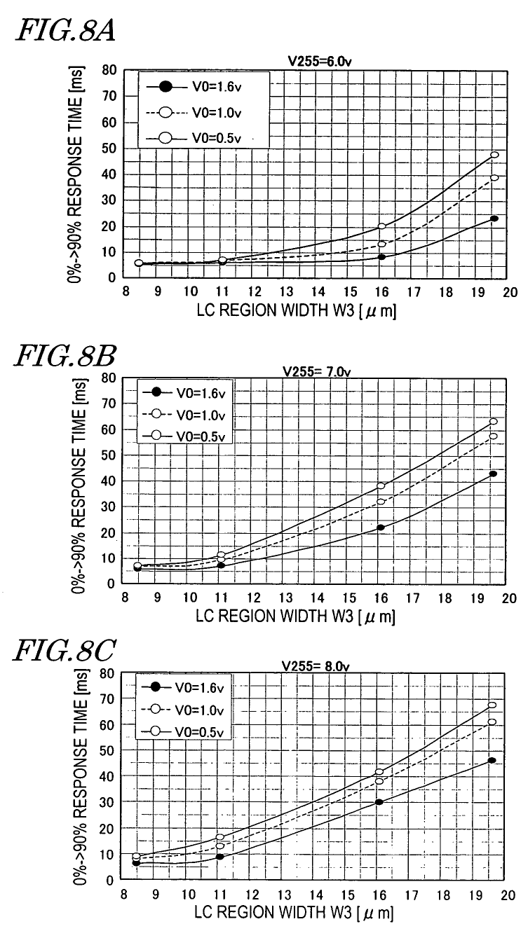

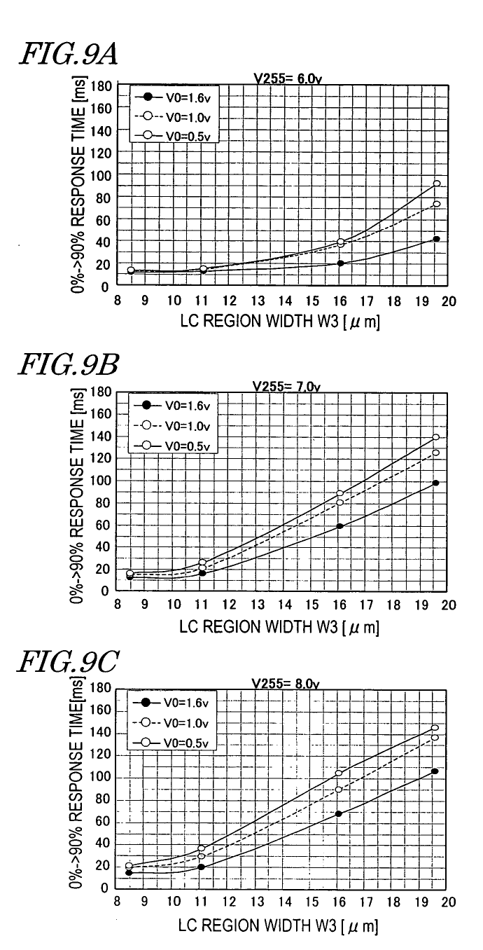

FIGS. 8A to 8C and 9A to 9C show the results of measurement of the response time (ms) with varying LC region widths W3. The response time as used herein refers to the time taken for the transmittance to reach 90% from 0% with respect to the transmittance in the white display state as 100%. FIGS. 8A and 9A show the results when the white voltage (herein, the voltage corresponding to grayscale level 255, denoted by V255) is 6.0V, FIGS. 8B and 9B show the results when the white voltage is 7.0V, and FIGS. 8C and 9C show the results when the white voltage is 8.0V. In each graph, the results obtained when the black voltage (herein, the voltage corresponding to grayscale level 0, denoted by V0) is 0.5V, 1.0V and 1.6V are shown. The cell parameters of the LCDs used in this examination are as shown in Table 3.

TABLE 3

| | Rib | Slit | | | Measure- | |
|---|---|---|---|---|---|---|
| | width | width | Rib | Thickness d | ment | |
| | W1 | W2 | height | of LC layer | temp. | |
| FIGS. 8A-8C | 8 μm | 10 μm | 1.05 μm | 2.5 μm | 25° | C. |
| FIGS. 9A-9C | 8 μm | 10 μm | 1.05 μm | 2.5 μm | 5° | C. |

From FIGS. 8A to 8C and 9A to 9C, it is found that a strong correlation exists between the LC region width W3 and the response time. Specifically, by reducing the LC region width W3, the response time decreases, that is, the response characteristic improves. From comparison between FIGS. 8A to 8C and FIGS. 9A to 9C, it is also found that the response time is longer and thus the response characteristic is lower when the operating temperature is 5° C. than when it is 25° C. Further, from comparison among FIGS. 8A, 8B and 8C and comparison among FIGS. 9A, 9B and 9C, it is found that the response time is longer and thus the response characteristic is lower when the white voltage is 7.0V and 8.0V than when it is 6.0 V. This is a phenomenon opposite to the general recognition that the response characteristic is higher as the applied voltage is higher.

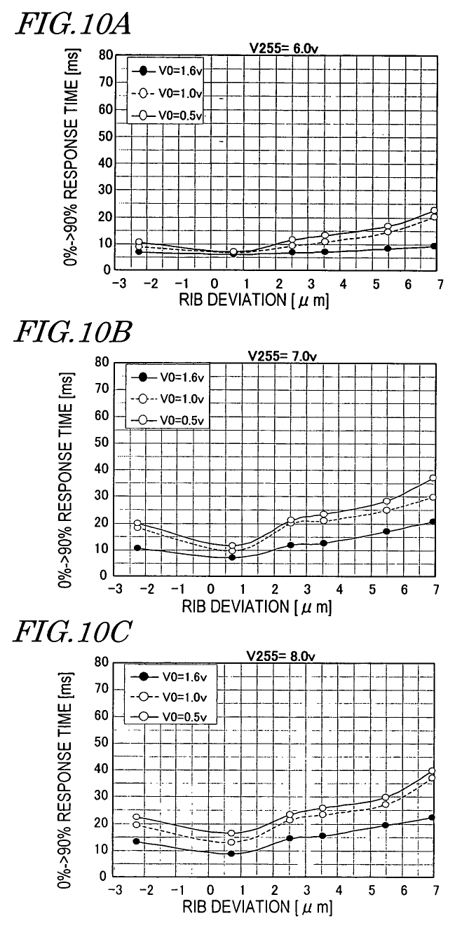

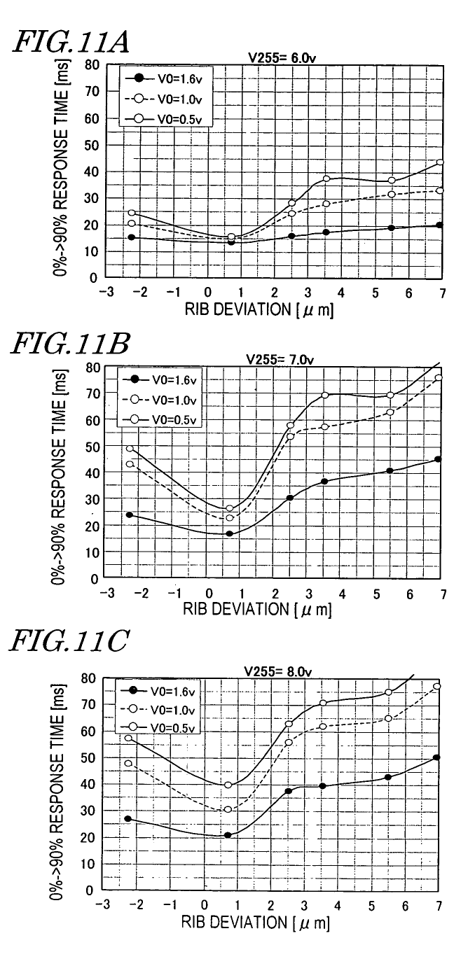

FIGS. 10A to 10C and 11A to 11C show the results of measurement of the response time (ms) with varying rib deviation amounts (the positions of the ribs were deviated intentionally). The cell parameters of the LCDs used in this examination are as shown in Table 4. The “rib deviation amount” as used herein is defined as the degree of deviation along the direction orthogonal to the extension of the ribs 21. Hence, if a rib deviation of X μm occurs, a difference of 2X μm is produced in LC region width W3 between the two liquid crystal regions adjacent to each other via the rib 21. For example, in the LCDs used in this examination, the LC region width W3 having no rib deviation is 11 μm. If the rib deviation amount is 2 μm, the widths W3 of the two liquid crystal regions adjacent to each other via the rib are 9 μm and 13 μm.

TABLE 4

| | Rib | Slit | | | Thickness | Meas- | |
|---|---|---|---|---|---|---|---|
| | width | width | LC region | Rib | d of LC | ure | |
| | W1 | W2 | width W3* | Height | layer | temp. | |
| FIGS. | 8 μm | 10 μm | 11 μm | 1.05 μm | 2.5 μm | 25° | C. |
| 10A-10C | | | | | | | |
| FIGS. | 8 μm | 10 μm | 11 μm | 1.05 μm | 2.5 μm | 5° | C. |
| 11A-11C | | | | | | | |

*The LC region width W3 measured when there is no rib deviation.

From FIGS. 10A to 10C and 11A to 11C, it is found that the correlation exists between the rib deviation amount and the response time. That is, as the rib deviation amount is smaller, the response time is shorter, that is, the response characteristic is higher.

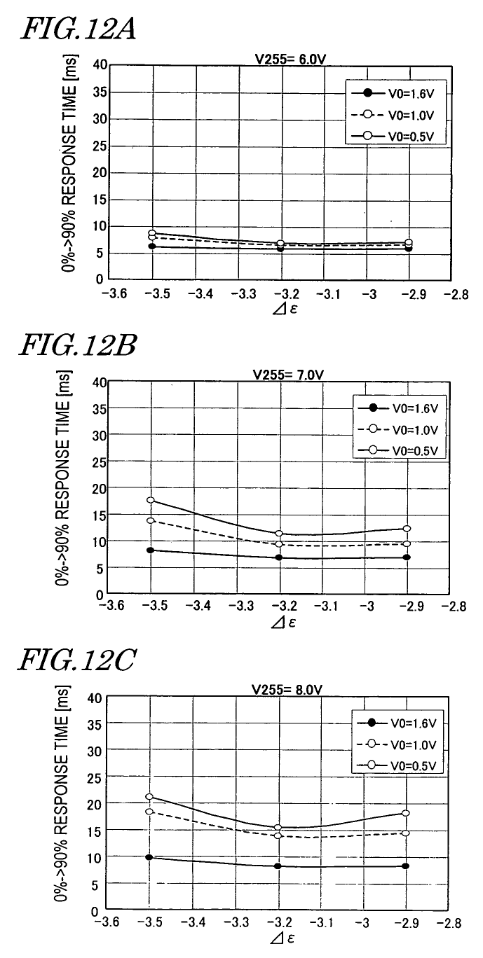

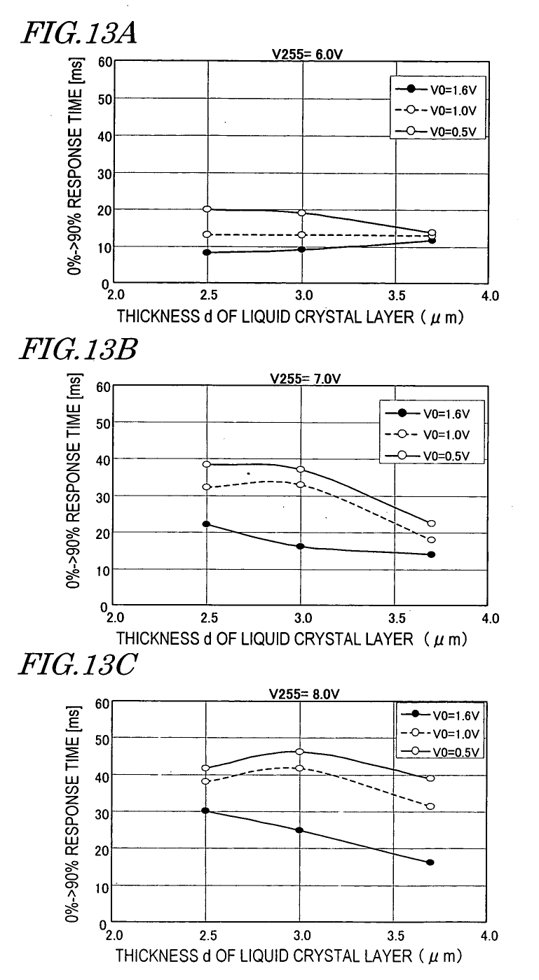

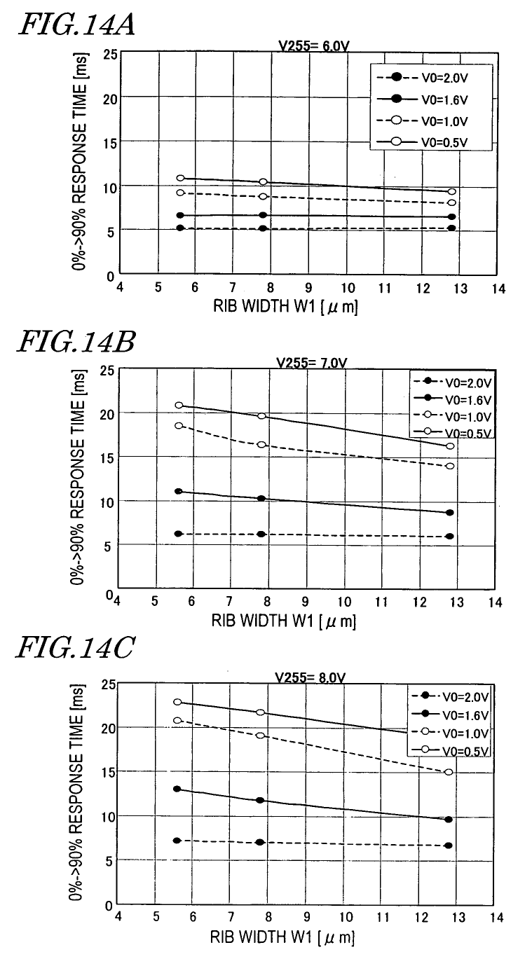

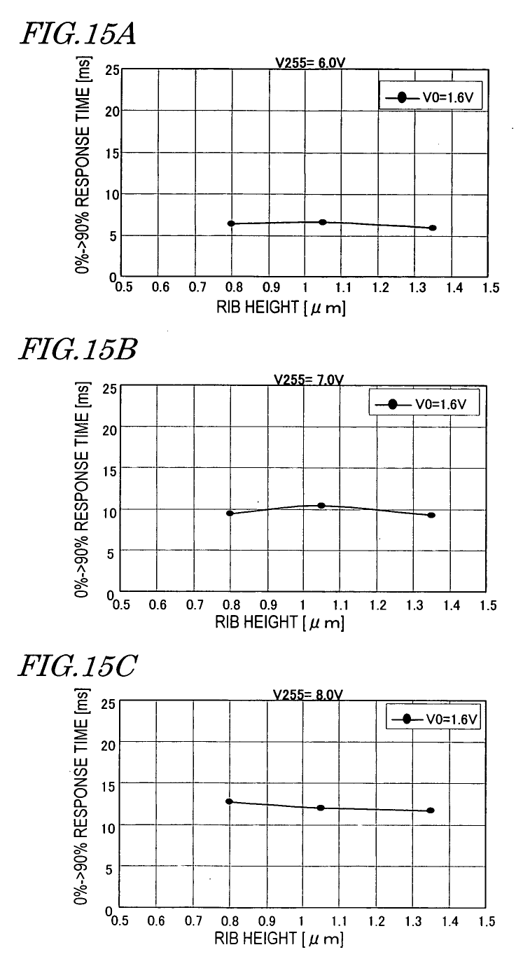

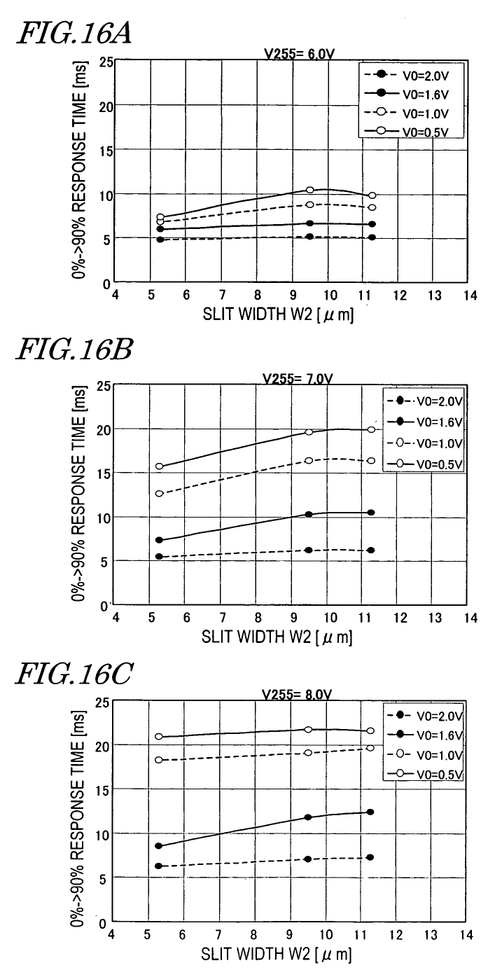

FIGS. 12A to 12C, 13A to 13C, 14A to 14C, 15A to 15C, and 16A to 16C show the results of measurement of the response time (ms) with varying Δε values of the liquid crystal material, thicknesses d of the liquid crystal layer, rib widths W1, rib heights, and slit widths W2, respectively. The cell parameters of the LCDs used in this examination are as shown in Tables 5 to 9.

TABLE 5

| | Rib | Slit | | | Thickness | Meas- |
|---|---|---|---|---|---|---|
| | width | width | LC region | Rib | d of LC | ure |
| | W1 | W2 | width W3 | height | layer | temp. |
| FIGS. | 8 μm | 10 μm | 11 μm | 1.05 μm | 2.5 μm | 25° C. |
| 12A-12C | | | | | | |

TABLE 6

| | Rib | Slit | | | |
|---|---|---|---|---|---|
| | width | width | LC region | Rib | Measurement |
| | W1 | W2 | width W3 | height | temp. |
| FIGS. | 8 μm | 10 μm | 15 μm, 16 μm | 1.05 μm | 25° C. |
| 13A-13C | | | | | |

TABLE 7

| | Slit width | LC region | Rib | Measurement |
|---|---|---|---|---|
| | W2 | width W3 | height | temp. |
| FIGS. | 10 μm | 11 μm | 1.05 μm | 25° C. |
| 14A-14C | | | | |

TABLE 8

| | Rib width | Slit width | LC region | Measurement |
|---|---|---|---|---|
| | W1 | W2 | width W3 | temp. |
| FIGS. | 8 μm | 10 μm | 11 μm | 25° C. |
| 15A-15C | | | | |

TABLE 9

| | Rib width | LC region | Rib | Measurement |
|---|---|---|---|---|
| | W1 | width W3 | height | temp. |
| FIGS. | 8 μm | 11 μm | 1.05 μm | 25° C. |
| 16A-16C | | | | |

From FIGS. 12A/B/C to 16A/B/C, it is found that the changes in response characteristic with changes of ΔE of the liquid crystal material, the thickness d of the liquid crystal layer, the rib width W1, the rib height and the slit width W2 are minute, and thus the response speed improving effects obtained by adjusting these factors are all small.

As described above, it was found that the response characteristic could be greatly improved by narrowing the LC region width W3 among various cell parameters of the LCDs, and that the response characteristic could also be improved to some extent by reducing the rib deviation amount.

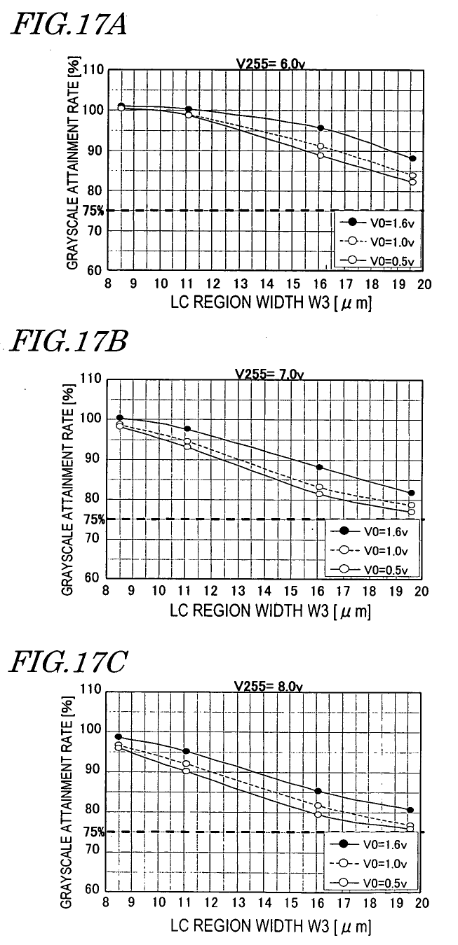

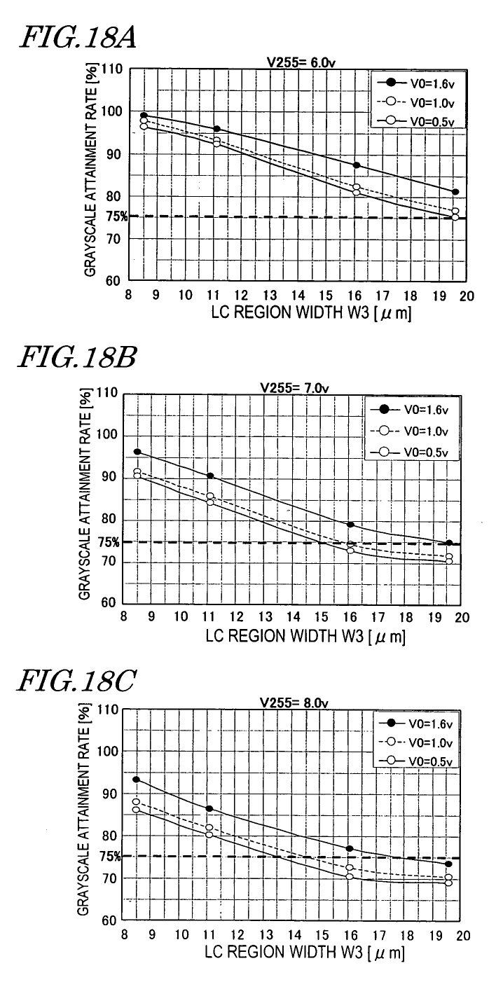

FIGS. 17A to 17C and 18A to 18C show the results of measurement of the grayscale attainment rate (%) with varying LC region widths W3. The “grayscale attainment rate” refers to the rate of the transmittance obtained when the time corresponding to one vertical scanning period (herein, 16.7 msec) has passed after voltage application to the transmittance corresponding to the target grayscale level. Herein, the grayscale attainment rate is that obtained when the initial state is the black display state and the target grayscale level is the highest grayscale level (white display state). The cell parameters of the LCDs used in this examination are the same as those shown in Table 3. FIGS. 17A to 17C show the results measured at 25° C., and FIGS. 18A to 18C show the results measured at 5° C.

From FIGS. 17A to 17C, it is found that the grayscale attainment rate is 75% or more in the range of the varying LC region widths W3 (about 8.5 μm to about 19.5 μm) at 25° C. From FIGS. 18A to 18C, it is found that at 5° C., a grayscale attainment rate of 75% or more may not be obtained unless the LC region width W3 is a predetermined value or less, depending on the magnitudes of the white voltage and black voltage.

Hereinafter, the effect obtained by securing a grayscale attainment rate of 75% or more will be described.

In the OS driving, to attain good display, the magnitude (level) of the OS voltage preferably changes continuously with the change of the target grayscale level. Herein, the magnitude (level) of the OS voltage expressed in terms of the grayscale level is called an “OS grayscale level”. For example, “OS grayscale level 128” indicates that a voltage of the same magnitude (level) as the grayscale voltage for grayscale level 128 is applied as the OS voltage.

The transmittance equivalent to 75% of the transmittance in the white display state (highest grayscale display) corresponds to grayscale level 224 in the grayscale display from level 0 (black) to level 255 (white) in γ^{2.2}. If the grayscale attainment rate is less than 75%, the transmittance corresponding to grayscale level 224 cannot be reached within one vertical scanning period in the shift of display from level 0 to level 224 even when the highest grayscale voltage (OS grayscale level 255) is applied as the OS voltage. Thus, the OS grayscale level for all target grayscale levels from a given grayscale level lower than 224 up to level 255 must be set at 255, and this results in loss of the continuity of the change in OS grayscale level from the given level to level 255. On the contrary, if the grayscale attainment rate is 75% or more, the OS grayscale levels at least from level 0 to level 224 change continuously, and thus display can be done with no practical problem.

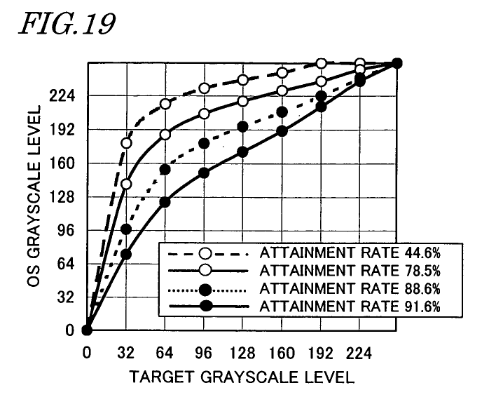

FIG. 19 shows the relationship between the target grayscale level and the OS grayscale level when a shift is made from level 0 to a given target grayscale level, for the cases of the grayscale attainment rate of 44.6%, 78.5%, 88.6% and 91.6% in an LCD having given cell parameters. As shown in FIG. 19, while the OS grayscale level continuously changes in the cases of the grayscale attainment rate of 78.5%, 88.6% and 91.6%, the OS grayscale level saturates (OS grayscale level is “flattened”) for grayscale levels 192 and higher in the case of the grayscale attainment rate of 44.6%, resulting in loss of the continuity of the change in OS voltage.

As described above, by securing a grayscale attainment rate of 75% or more, good display can be obtained when the OS driving is adopted. As the grayscale attainment rate is higher, the continuity in OS grayscale level can be secured up to a higher grayscale level, and thus better display can be obtained. Hence, the grayscale attainment rate is preferably 75% or more, and a higher rate is more preferable.

From the results shown in FIGS. 18A to 18C, it is found that the LC region width W3 enabling a grayscale attainment rate of 75% or more is as shown in Tables 10 to 12. Note that Tables 10 to 12 also show the LC region widths W3 enabling a grayscale attainment rate of 80% or more and a grayscale attainment rate of 85% or more.

TABLE 10
White voltage 6.0 V

| | Black voltage | | |
|---|---|---|---|
| | 0.5 V | 1.0 V | 1.6 V |
| LC region width W3 enabling | 19.5 μm | | |
| grayscale attainment rate of 75% or | or less | | |
| more | | | |
| LC region width W3 enabling | 16.5 μm | 17.5 μm | |
| grayscale attainment rate of 80% or | or less | or less | |
| more | | | |
| LC region width W3 enabling | 14.3 μm | 15 μm | 17.5 μm |
| grayscale attainment rate of 85% or | or less | or less | or less |
| more | | | |

TABLE 11
White voltage 7.0 V

| | Black voltage | | |
|---|---|---|---|
| | 0.5 V | 1.0 V | 1.6 V |
| LC region width W3 enabling | 15.0 μm | 16.0 μm | 19.5 μm |
| grayscale attainment rate of 75% or | or less | or less | or less |
| more | | | |
| LC region width W3 enabling | 12.8 μm | 13.5 μm | 15.5 μm |
| grayscale attainment rate of 80% or | or less | or less | or less |
| more | | | |
| LC region width W3 enabling | 10.8 μm | 11.5 μm | 13.5 μm |
| grayscale attainment rate of 85% or | or less | or less | or less |
| more | | | |

TABLE 12
White voltage 8.0V

| | Black voltage | | |
|---|---|---|---|
| | 0.5 V | 1.0 V | 1.6 V |
| LC region width W3 enabling | 13.5 μm | 14.5 μm | 17.8 μm |
| grayscale attainment rate of 75% or | or less | or less | or less |
| more | | | |
| LC region width W3 enabling | 11.0 μm | 12.0 μm | 14.5 μm |
| grayscale attainment rate of 80% or | or less | or less | or less |
| more | | | |
| LC region width W3 enabling | 9.0 μm | 9.8 μm | 11.8 μm |
| grayscale attainment rate of 85% or | or less | or less | or less |
| more | | | |

From the above tables, it is found that by setting the LC region width W3 at about 15 μm or less, a grayscale attainment rate of 75% or more can be obtained in driving with a white voltage of 7.0V and a black voltage of 0.5V at a panel temperature of 5° C. It is also found that by setting the LC region width W3 at about 13.5 μm or less, for example, a grayscale attainment rate of 75% or more can be obtained in driving with a white voltage of 8.0V and a black voltage of 0.5V at a panel temperature of 5° C.

Conventional alignment-divided vertical alignment LCDs were often driven with a white voltage of about 6.0 V and a black voltage of about 1.6 V. As described above, by setting the LC region width W3 at about 15 μm or less (more preferably, about 13.5 μm or less, for example), a grayscale attainment rate of 75% or more can be obtained under the driving conditions of a higher white voltage and a lower black voltage than those conventionally adopted, and yet occurrence of alignment deflection can be suppressed. Thus, MVA LCDs excellent in moving image display characteristics can be obtained.

The LC region width W3 of the currently commercially available MVA LCDs (including the PVA LCD shown in FIG. 1C) is larger than 15 μm. According to the results described above, if the devices are driven with a high white voltage and a low black voltage at a panel temperature of 5° C., the grayscale attainment rate may not reach 75% in some cases.

Hereinafter, the reason why the response characteristic is improved by reducing the LC region width W3 will be described.

As already described, alignment deflection occurs due to the existence of the first LC portion R1 high in response speed and the second LC portion R2 low in response speed in each liquid crystal region 13A. The width of the first LC portion R1 located near an alignment regulating means (herein, the width is not quantitatively expressed) is determined with the strength of the alignment regulating force of the alignment regulating means. It is therefore considered that if the alignment regulating force of the alignment regulating means is uniform (for example, the size of the alignment regulating means is uniform), the width of the first LC portion R1 little changes with change of the LC region width W3. Hence, when the LC region width W3 is reduced, the width of the second LC portion R2 alone decreases. Thus, by reducing the LC region width W3, the width of the second LC portion R2 low in response speed is reduced, whereby occurrence of alignment deflection is suppressed and the response speed of the entire liquid crystal region 13A is improved.

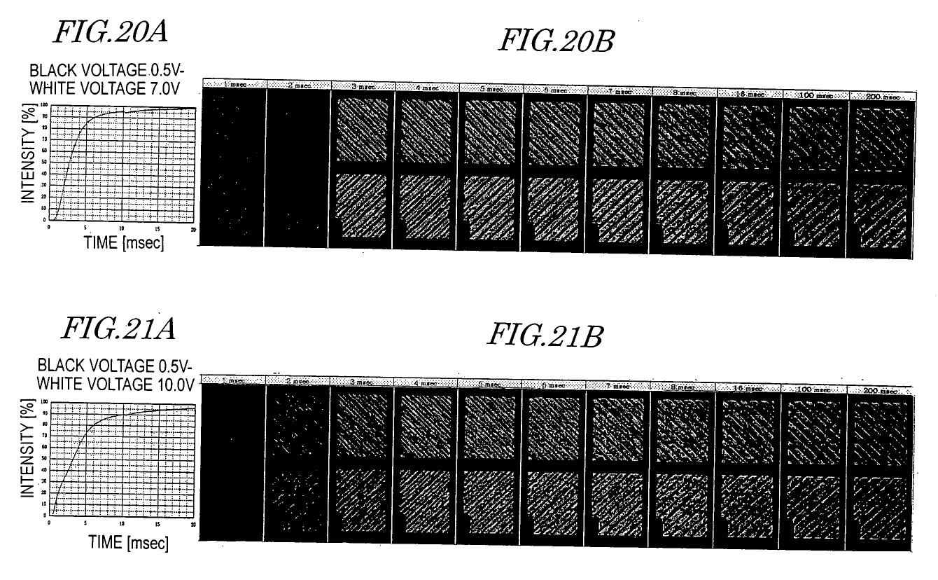

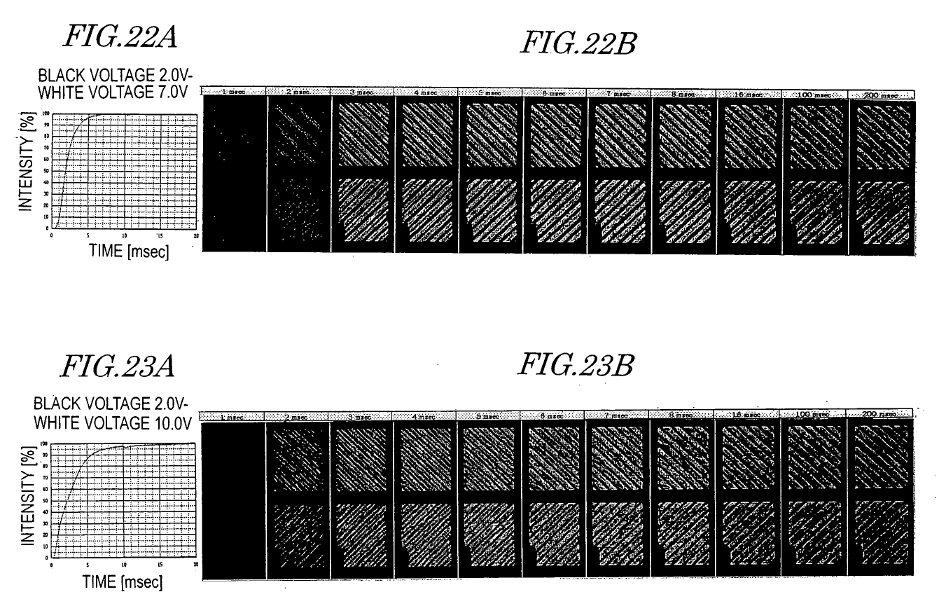

FIGS. 20A/B to 23A/B show how the alignment deflection is suppressed by setting the LC region width W3 at a predetermined value or less. FIGS. 20A, 21A, 22A and 23A are graphs showing a change of the intensity of transmitted light with time observed when a shift is made from the black display state to the white display state. FIGS. 20B, 21B, 22B and 23B show continuous photos of a pixel portion taken at the shift from the black display state to the white display state with a high-speed camera. The specific cell parameters of the LCDs 100 used in this examination are the same as those shown in Table 1 except that the width W3 of the liquid crystal region 13A is 8 μm. The black voltage (V0) and the white voltage (V255) for the respective figures are as shown in Table 13. That is, FIGS. 20A/B to 23A/B respectively correspond to FIGS. 4A/B to 7A/B.

TABLE 13

| | |
|---|---|
| Black voltage | White voltage |

| | | | |
|---|---|---|---|
| 0.5 | V | 7 | V |
| 0.5 | V | 10 | V |
| 2 | V | 7 | V |
| 2 | V | 10 | V |

As is apparent from comparison of FIGS. 20A/B to 23A/B with 4A/B to 7A/B, the alignment deflection was suppressed and the response characteristic was improved when the LC region width W3 was 8 μm compared with when it was 19 μm.

As described above, by reducing the LC region width W3, the alignment deflection can be suppressed and the response characteristic can be improved. This provides an LCD permitting good moving image display. If the LC region width W3 is less than 2 μm, however, fabrication of the LCD is difficult. Therefore, the LC region width W3 is preferably 2 μm or more. For the same reason, the rib width W1 and the slit width W2 are preferably 4 μm or more. Typically, the rib width W1 and the slit width W2 are 20 μm or less.

As is found from FIGS. 2 and 3, reducing the LC region width W3 leads to lowering the aperture ratio {(pixel area−rib area−slit area)/pixel area}. Therefore, to think of this simply, it is presumed that the display luminance will also be lowered.

However, it was clarified from the series of examinations conducted in relation to the present invention that the MVA LCD of this embodiment could keep its display luminance from lowering despite the decrease of the LC region width W3 from that conventionally used. This is thanks to an unexpected effect that the transmittance per unit area of pixels (hereinafter, called the “transmission efficiency”) improves by reducing the LC region width W3 from the conventional width. The transmission efficiency is determined by actually measuring the transmittance of pixels and dividing the measured value by the aperture ratio.

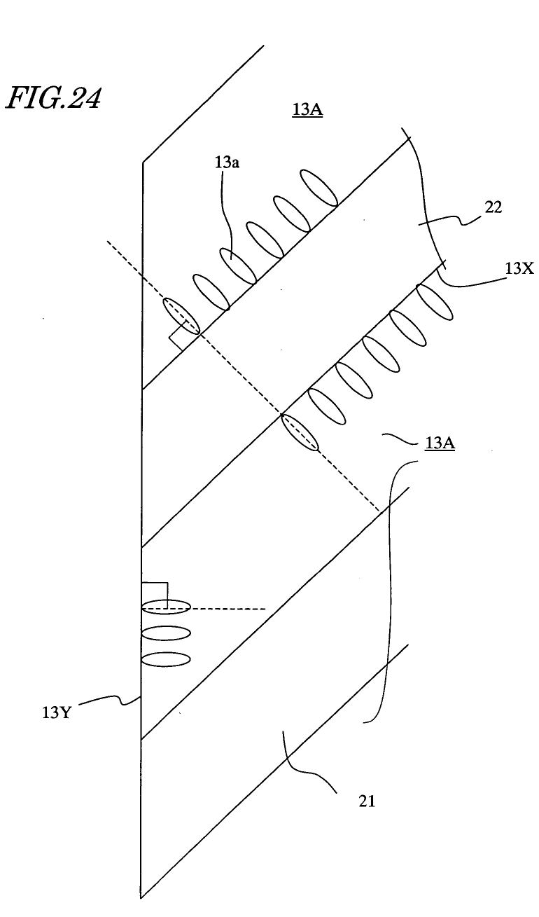

The reason why the transmission efficiency improves by reducing the LC region width W3 will be described with reference to FIG. 24. FIG. 24 diagrammatically shows how the liquid crystal molecules 13a located near the slit 22 in the liquid crystal region 13A are aligned. Among the liquid crystal molecules 13a in the liquid crystal region 13A, those located near a side (longer side) 13×of the stripe-shaped liquid crystal region 13A tilt in the plane perpendicular to the side 13X under the influence of a tilt electric field. On the contrary, the liquid crystal molecules 13a located near a side (shorter side) 13Y of the liquid crystal region 13A intersecting the side 13X tilt in a direction different from the direction of the tilt of the liquid crystal molecules 13a near the side 13X, under the tilt electric field. In other words, the liquid crystal molecules 13a located near the side 13Y of the liquid crystal region 13A tilt in a direction different from a predetermined alignment direction defined by the alignment regulating force of the slit 22, acting to disturb the alignment of the liquid crystal molecules 13a in the liquid crystal region 13A. By reducing the width W3 of the liquid crystal region 13A (that is, reducing the value of (length of longer side/length of shorter side)), the proportion of the liquid crystal molecules 13a that tilt in the predetermined direction under the influence of the alignment regulating force of the slit 22, among the liquid crystal molecules 13a in the liquid crystal region 13A, increases, resulting in increase in transmission efficiency. In this way, by reducing the LC region width W3, obtained is the effect of stabilizing the alignment of the liquid crystal molecules 13a in the liquid crystal region 13A, and as a result, the transmission efficiency improves.

From examinations in various ways, it has been found that the effect of stabilizing the alignment (effect of improving the transmission efficiency) obtained by reducing the LC region width W3 is exhibited significantly when the thickness d of the liquid crystal layer is small, for example, as small as less than 3.2 μm. The reason is considered to be as follows. As the thickness d of the liquid crystal layer is smaller, the action of the tilt electric field from the slit 22 is greater. However, at the same time, the liquid crystal layer is more affected by the electric field from gate bus lines and source bus lines placed in the vicinity of the pixel electrode 12, or the electric field from adjacent pixel electrodes. These electric fields act to disturb the alignment of the liquid crystal molecules 13a in the liquid crystal layer 13A. Therefore, it can be said that the alignment stabilizing effect described above is exhibited significantly in the case that the thickness d of the liquid crystal layer is small in which the alignment of the liquid crystal molecules 13a tend to be disturbed.

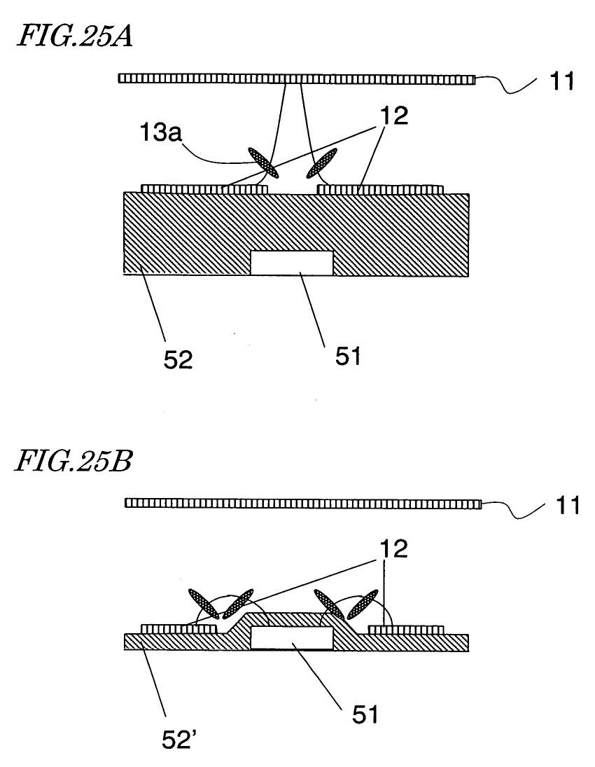

The LCD exemplified in this embodiment includes the comparatively thick interlayer insulating film 52 covering the gate bus lines and the source bus lines, and the pixel electrode 12 is formed on the interlayer insulating film 52, as shown in FIG. 2. The influence of the interlayer insulating film 52 on the alignment of the liquid crystal molecules 13a will be described with reference to FIGS. 25A and 25B.

As shown in FIG. 25A, the interlayer insulating film 52 of the LCD of this embodiment is comparatively thick (for example, the thickness is in the range between about 1.5 μm and about 3.5 μm). Therefore, even if the pixel electrode 12 and a gate bus line or a source bus line 51 overlap each other via the interlayer insulating film 52 therebetween, a capacitance formed therebetween is too small to give an influence on the display quality. Also, the alignment of the liquid crystal molecules 13a existing between the adjacent pixel electrodes 12 is mostly influenced by the tilt electric field generated between the counter electrode 11 and the pixel electrodes 12, as diagrammatically shown by the electric lines of force in FIG. 25A, and hardly influenced by the source bus line 51.

On the contrary, as diagrammatically shown in FIG. 25B, when a comparatively thin interlayer insulating film 52′ (for example, an SiO₂ film having a thickness of several hundred nanometers) is formed, a comparatively large capacitance will be formed if the source bus line 51, for example, and the pixel electrode 12 overlap each other via the interlayer insulting film 52′ therebetween, resulting in degradation of the display quality. To prevent this problem, arrangement is made to avoid overlap between the pixel electrode 12 and the source bus line 51. In this arrangement, the liquid crystal molecules 13a existing between the adjacent pixel electrodes 12 are largely influenced by the electric field generated between the pixel electrodes 12 and the source bus line 51, as shown by the electric lines of force in FIG. 25B, resulting in disturbance of the alignment of the liquid crystal molecules 13a located at the ends of the pixel electrodes 12.

As is apparent from comparison between FIGS. 25A and 25B, by providing the comparatively thick interlayer insulating film 52 as in the exemplified LCD of this embodiment, the liquid crystal molecules 13a are substantially free from the influence of the electric field from the gate bus lines/source bus lines, and thus can be advantageously aligned favorably in a desired direction with the alignment regulating means. In addition, since the influence of the electric field from the bus lines is minimized with the comparatively thick interlayer insulating film 52, the alignment stabilizing effect obtained by reducing the thickness of the liquid crystal layer can be exhibited significantly.

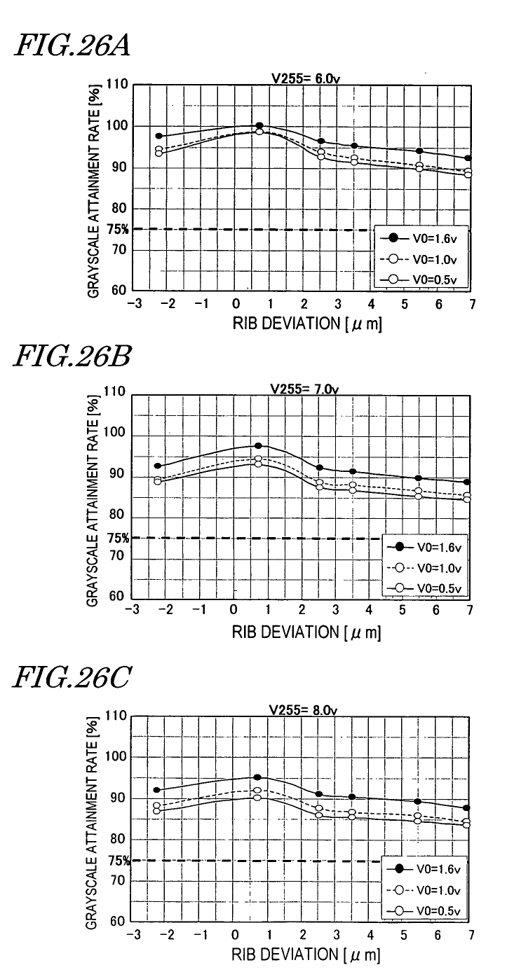

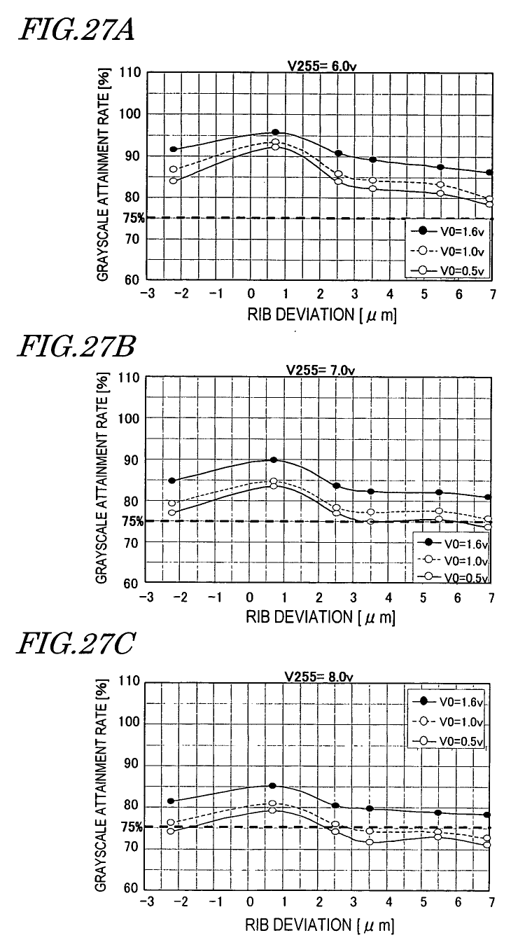

FIGS. 26A to 26C and 27A to 27C show the results of measurement of the grayscale attainment rate (%) with varying rib deviation amount. The cell parameters of the LCDs used in this examination are the same as those shown in Table 4. FIGS. 26A to 26C show the results measured at 25° C., and FIGS. 27A to 27C show the results measured at 5° C.

From FIGS. 26A to 26C, it is found that the grayscale attainment rate is 75% or more in the range of the varying rib deviation amounts (0 μm to about 7 μm) at 25° C. From FIGS. 27A to 27C, it is found that at 5° C., a grayscale attainment rate of 75% or more may not be obtained unless the rib deviation amount is a predetermined value or less, depending on the magnitudes of the white voltage and black voltage.

When a rib deviation occurs, the width W3 of part of the liquid crystal regions 13A becomes greater than the design value. Hence, if the rib deviation amount is large, the width W3 of the part of the liquid crystal regions 13A will exceed the range of values within which alignment deflection can be suppressed.

As described above, the fact that the grayscale attainment rate can be 75% or more by limiting the rib deviation amount to a predetermined value or less well corresponds to the fact that the grayscale attainment rate can be 75% or more by limiting the LC region width W3 to a predetermined value or less.

The four types of liquid crystal regions 13A different in the alignment direction of the liquid crystal molecules 13a by 90° from one another are typically designed so that the areas of these regions are roughly the same in each pixel. If a rib deviation arises, a difference will be produced among these areas. Therefore, a large rib deviation may result in display that makes the viewer feel strange. From the standpoint of keeping the viewer from feeling strange, also, the rib deviation amount is preferably small. According to examinations conducted by the present inventors, the rib deviation amount is preferably 7 μm or less, more preferably 5 μm or less.

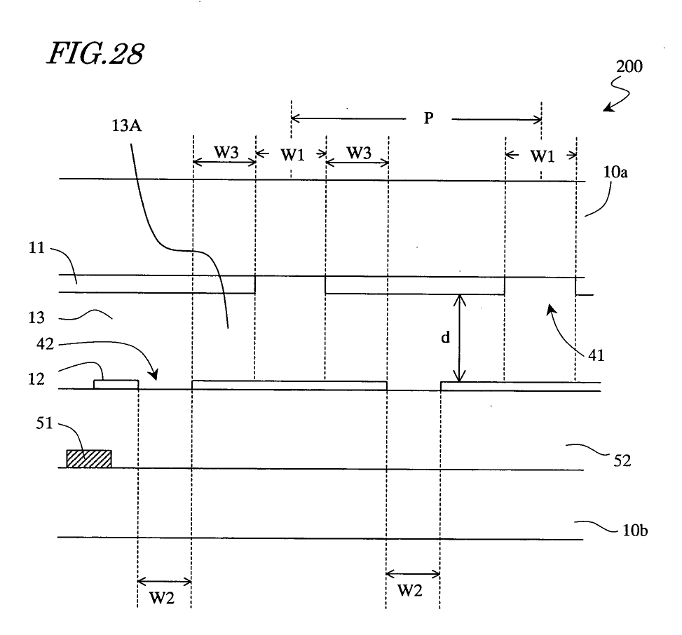

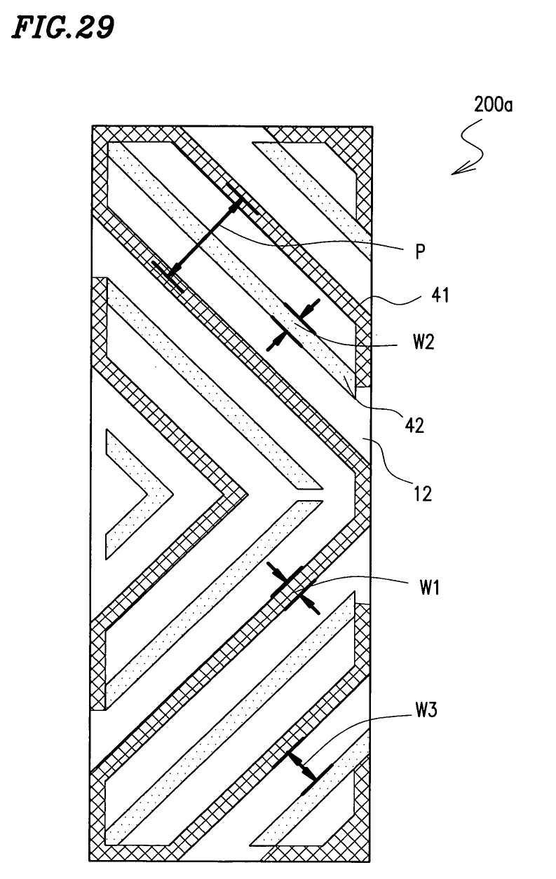

The evaluation results of the MVA LCD provided with the ribs 21 as the first alignment regulating means and the slits 22 as the second alignment regulating means have been described so far. Hereinafter, evaluation results of an MVA LCD 200 provided with slits 41 and 42 as the first and second alignment regulating means, as shown in FIGS. 28 and 29, will be described.

The LCD 200 shown in FIGS. 28 and 29 is the same in construction as the LCD 100 shown in FIGS. 2 and 3, except that the slits 41 and 42 are formed as the first and second alignment regulating means, which has the same basic construction as the LCD 10C shown in FIG. 1C. Common components are therefore denoted by the same reference numerals, and the description thereof is omitted here. An MVA LCD provided with slits as the first and second alignment regulating means, like the LCD 200, may also be called a patterned vertical alignment (PVA) LCD.

For the purpose of preventing occurrence of alignment deflection, MVA LCDs having the basic construction shown in FIGS. 28 and 29 were fabricated by varying the cell parameters (the thickness d of the liquid crystal layer, the slit width W1 in the counter electrode 11, the slit width W2 in the pixel electrode 12, the LC region width W3 and the like), and the response characteristics of these devices were evaluated.

As a result, the following were found. The changes in response characteristic with changes of the slit width W1 in the counter electrode 11 and the slit width W2 in the pixel electrode 12 were minute, and thus the response speed improving effects obtained by adjusting these factors were all small. On the contrary, as in the LCD 100, the response characteristic was greatly improved by narrowing the LC region width W3. Hereinafter, the results of the evaluation will be described in detail.

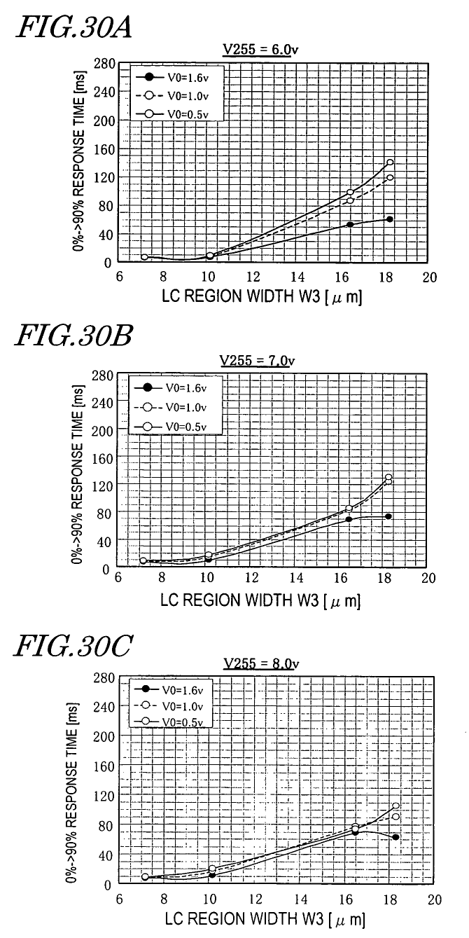

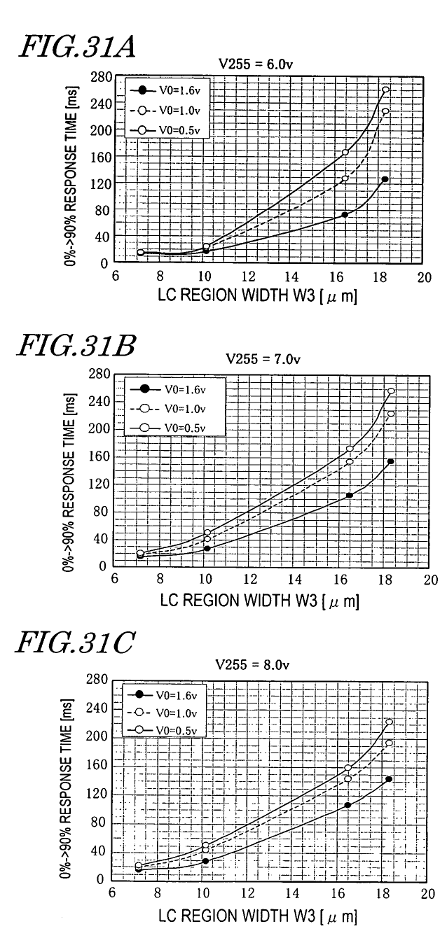

FIGS. 30A to 30C and 31A to 31C show the results of measurement of the response time (ms) with varying LC region widths W3. The cell parameters of the LCDs used in this examination are as shown in Table 14.

TABLE 14

| | Slit width W1 | Slit width W2 | Thickness | Meas- | |
|---|---|---|---|---|---|
| | in counter | in pixel | d of LC | ure | |
| | electrode | electrode | layer | temp. | |
| FIGS. 30A-30C | 10 μm | 10 μm | 2.5 μm | 25° | C. |
| FIGS. 31A-31C | 10 μm | 10 μm | 2.5 μm | 5° | C. |

From FIGS. 30A to 30C and 31A to 31C, it is found that a strong correlation exists between the LC region width W3 and the response time. Specifically, by reducing the LC region width W3, the response time decreases, that is, the response characteristic improves. From comparison between FIGS. 30A to 30C and FIGS. 31A to 31C, it is also found that the response time is longer and thus the response characteristic is lower when the operating temperature is 5° C. than when it is 25° C.

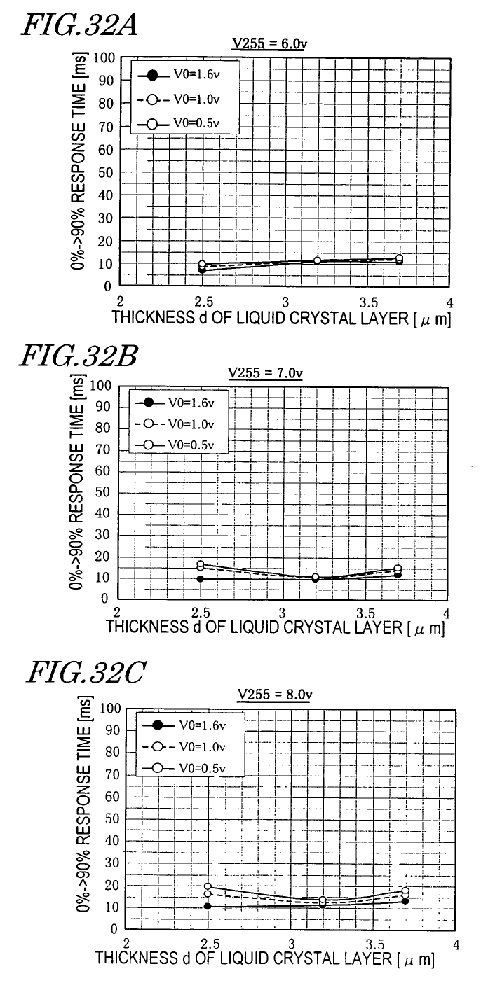

FIGS. 32A to 32C, 33A to 33C and 34A to 34C show the results of measurement of the response time (ms) with varying thicknesses d of the liquid crystal layer, slit widths W1 in the counter electrode 11 and slit widths W2 in the pixel electrode 12, respectively. The cell parameters of the LCDs used in this examination are as shown in Tables 15 to 17.

TABLE 15

| | Slit width W1 | Slit width W2 | | Meas- |
|---|---|---|---|---|
| | in counter | in pixel | LC region | ure |
| | electrode | electrode | width W3 | temp. |
| FIGS. 32A-32C | 10 μm | 10 μm | 10 μm | 25° C. |

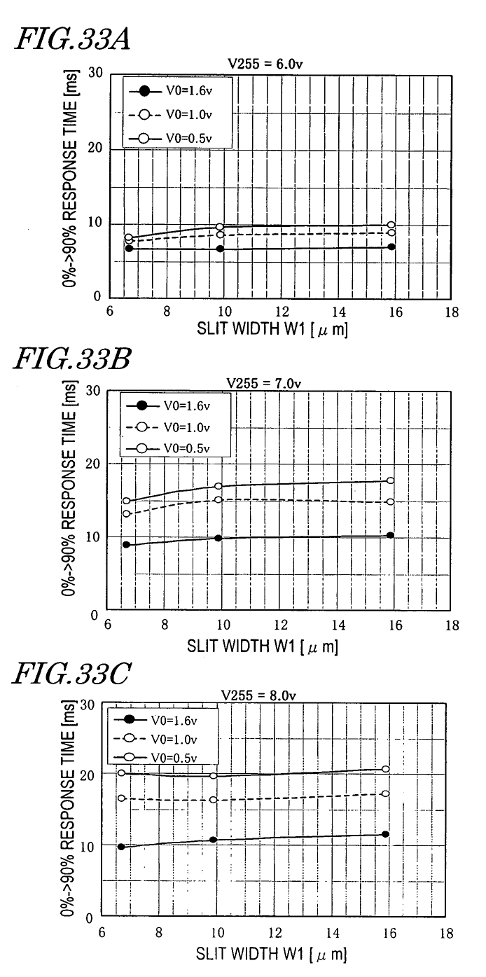

TABLE 16

| | Slit width W2 | | Thickness | Meas- |
|---|---|---|---|---|
| | in pixel | LC region | d of LC | ure |
| | electrode | width W3 | layer | temp. |
| FIGS. 33A-33C | 10 μm | 10 μm | 2.5 μm | 25° C. |

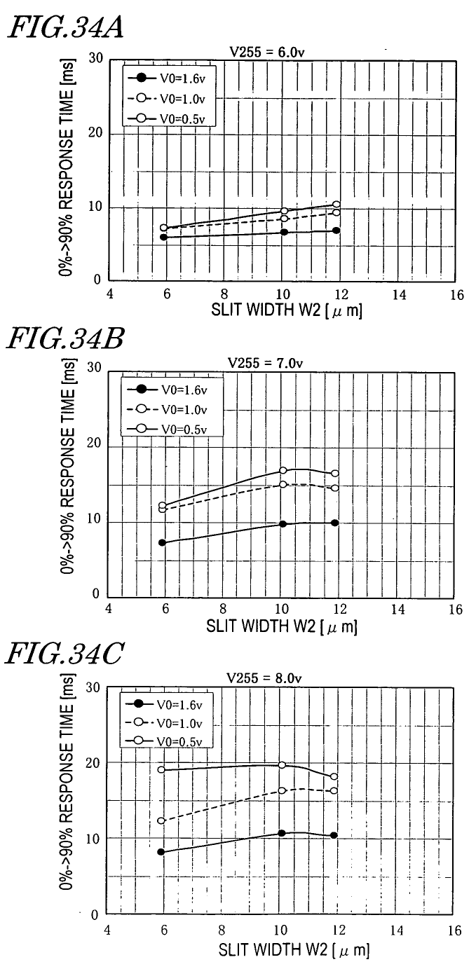

TABLE 17

| | Slit width W1 | | Thickness | Meas- |
|---|---|---|---|---|
| | in counter | LC region | d of LC | ure |
| | electrode | width W3 | layer | temp. |
| FIGS. 34A-34C | 10 μm | 10 μm | 2.5 μm | 25° C. |

From FIGS. 32A to 32C, 33A to 33C and 34A to 34C, it is found that the changes in response characteristic with changes of the thickness d of the liquid crystal layer, the slit width W1 in the counter electrode 11 and the slit width W2 in the pixel electrode 12 are minute, and thus the response speed improving effects obtained by adjusting these factors are all small.

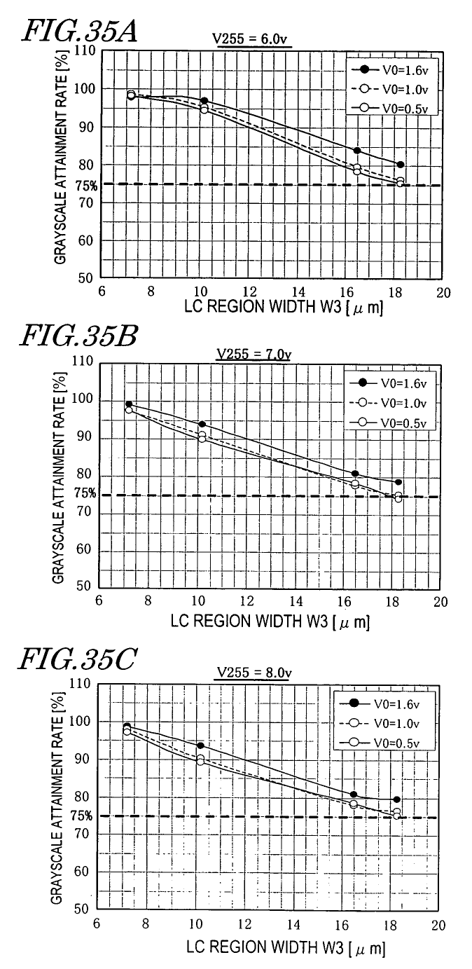

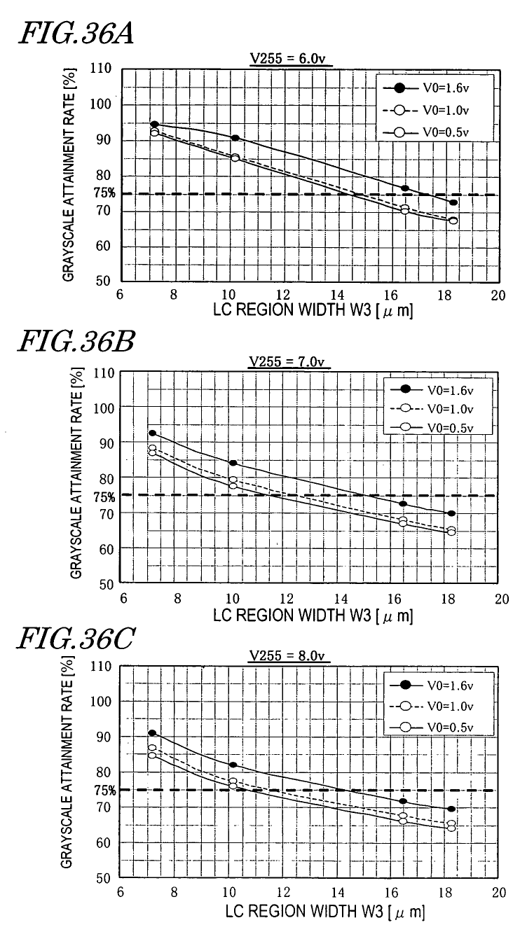

As described above, it was found that the response characteristic could be greatly improved by narrowing the LC region width W3, among the various cell parameters of the LCDs. FIGS. 35A to 35C and 36A to 36C show the results of measurement of the grayscale attainment rate (%) with varying LC region widths W3. The cell parameters of the LCDs used in this examination are the same as those shown in Table 14. FIGS. 35A to 35C show the results measured at 25° C., and FIGS. 36A to 36C show the results measured at 5° C.

From FIGS. 35A to 35C, it is found that the grayscale attainment rate is about 75% or more in the range of the varying LC region widths W3 (about 7.0 μm to about 18.5 μm) at 25° C. From FIGS. 36A to 36C, it is found that at 5° C., a grayscale attainment rate of 75% or more may not be obtained unless the LC region width W3 is a predetermined value or less, depending on the magnitudes of the white voltage and black voltage.

From the results shown in FIGS. 36A to 36C, it is found that the LC region width W3 enabling a grayscale attainment rate of 75% or more is as shown in Tables 18 to 20. Note that Tables 18 to 20 also show the LC region widths W3 enabling a grayscale attainment rate of 80% or more and a grayscale attainment rate of 85% or more.

TABLE 18
White voltage 6.0 V

| | Black voltage | | |
|---|---|---|---|
| | 0.5 V | 1.0 V | 1.6 V |
| LC region width W3 enabling | 14.3 μm | 14.5 μm | 17.0 μm |
| grayscale attainment rate of 75% or | or less | or less | or less |
| more | | | |
| LC region width W3 enabling | 12.2 μm | 12.5 μm | 15.0 μm |
| grayscale attainment rate of 80% or | or less | or less | or less |
| more | | | |
| LC region width W3 enabling | 10.0 μm | 10.3 μm | 12.7 μm |
| grayscale attainment rate of 85% or | or less | or less | or less |
| more | | | |

TABLE 19
White voltage 7.0 V

| | Black voltage | | |
|---|---|---|---|
| | 0.5 V | 1.0 V | 1.6 V |
| LC region width W3 enabling | 11.3 μm | 12.2 μm | 15.0 μm |
| grayscale attainment rate of 75% or | or less | or less | or less |
| more | | | |
| LC region width W3 enabling | 9.2 μm | 9.8 μm | 12.2 μm |
| grayscale attainment rate of 80% or | or less | or less | or less |
| more | | | |
| LC region width W3 enabling | 7.6 μm | 8.0 μm | 9.6 μm |
| grayscale attainment rate of 85% or | or less | or less | or less |
| more | | | |

TABLE 20
White voltage 8.0 V

| | Black voltage | | |
|---|---|---|---|
| | 0.5 V | 1.0 V | 1.6 V |
| LC region width W3 enabling | 10.5 μm | 11.5 μm | 14.2 μm |
| grayscale attainment rate of 75% or | or less | or less | or less |
| more | | | |
| LC region width W3 enabling | 8.5 μm | 9.0 μm | 11.2 μm |
| grayscale attainment rate of 80% or | or less | or less | or less |
| more | | | |
| LC region width W3 enabling | 7.0 μm | 7.7 μm | 8.9 μm |
| grayscale attainment rate of 85% or | or less | or less | or less |
| more | | | |

From Tables 18 to 20, it is found that by setting the LC region width W3 at about 15 μm or less, a grayscale attainment rate of 75% or more can be obtained in driving with a white voltage of 7.0V and a black voltage of 1.6V at a panel temperature of 5° C. It is also found by setting the LC region width W3 at about 14.2 μm or less, for example, a grayscale attainment rate of 75% or more can be obtained in driving with a white voltage of 8.0V and a black voltage of 1.6V at a panel temperature of 5° C.

As described above, by setting the LC region width W3 at about 15 μm or less (more preferably, about 14.2 μm or less, for example), it is possible to obtain a grayscale attainment rate of 75% or more under the driving condition of a higher white voltage than that conventionally adopted, and yet occurrence of alignment deflection can be suppressed. Thus, MVA LCDs excellent in moving image display characteristics can be obtained. The reason why the response characteristic is improved by reducing the LC region width W3 is the same as that described in relation to the LCD 100 shown in FIGS. 2 and 3. While the black voltage of 0.5V was given as one of the evaluation criteria for the LCD 100, the black voltage of 1.6V was given for the LCD 200. The reason for this is that while the LCD 100 has the ribs 21 as alignment regulating means, the LCD 200 has no ribs but only has the slits 41 and 42 as the alignment regulating means. In the LCD 100, the contrast ratio decreases with tilt liquid crystal molecules near the ribs even during non-voltage application, and thus a lower black voltage is preferably used to improve the contrast ratio. In the LCD 200, having no such problem, the contrast ratio can be kept high with a higher black voltage. Naturally, in the LCD 200, also, a lower black voltage will exhibit a higher contrast ratio.

For the same reason as that described in relation to the LCD 100 (reason related to fabrication), the LC region width W3 is preferably 2 μm or more, and the slit width W1 in the counter electrode 11 and the silt width W2 in the pixel electrode 12 are preferably 4 μm or more. Typically, the slit widths W1 and W2 are 20 μm or less.

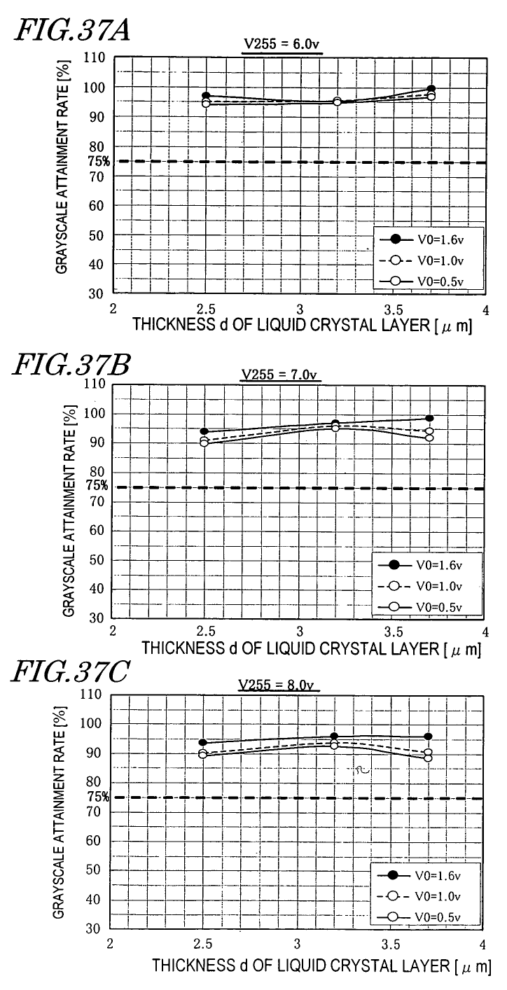

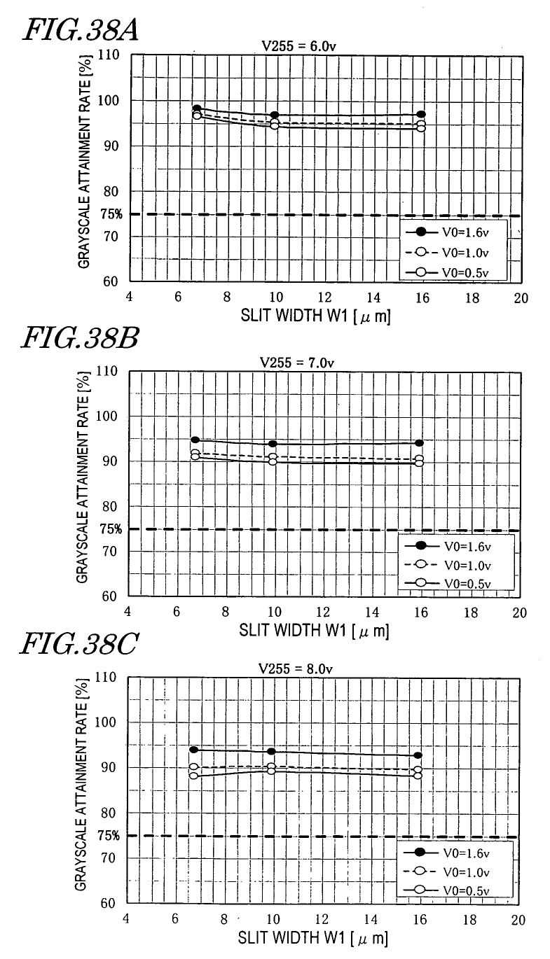

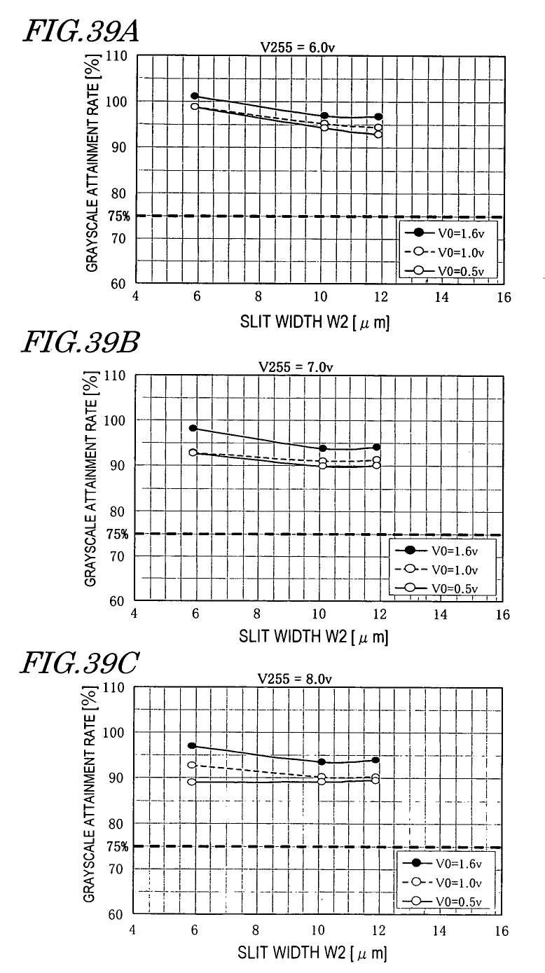

For reference, FIGS. 37A to 37C, 38A to 38C and 39A to 39C show the results of measurement of the grayscale attainment rate (%) with varying thicknesses d of the liquid crystal layer, slit widths W1 of the counter electrode 11, and slit widths W2 of the pixel electrode 12, respectively. The cell parameters of the LCDs used in this examination are the same as those shown in Tables 15 to 17.

From FIGS. 37A to 37C, 38A to 38C and 39A to 39C, it is found that the changes in grayscale attainment rate with changes of the thickness d of the liquid crystal layer, the slit width W1 in the counter electrode 11 and the slit width W2 in the pixel electrode 12 are minute, and thus the grayscale attainment rate improving effects obtained by adjusting these factors are all small.

The present invention is not limited to the exemplified LCDs 100 and 200, but is widely applicable to alignment-divided vertical alignment LCDs that perform alignment regulation using stripe-shaped first alignment regulating means and stripe-shaped second alignment regulating means. In alignment-divided vertical alignment LCDS, occurrence of alignment deflection can be suppressed by setting the LC region width at a predetermined value or less, and thus a grayscale attainment rate of 75% or more can be obtained at a panel temperature of 5° C., enabling good moving image display.

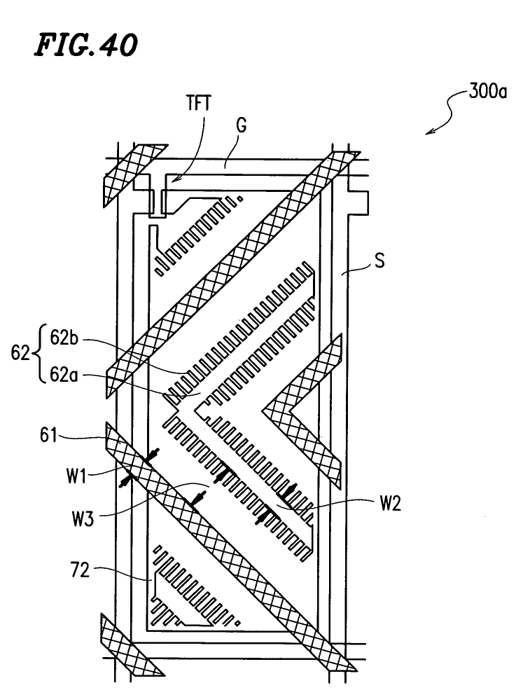

According to the present invention, alignment regulating means having a comb shape as is viewed from top can be used, as in an MVA LCD shown in FIG. 40, for example. In the MVA LCD having a pixel 300a shown in FIG. 40, a vertical alignment liquid crystal layer is alignment-divided with a pixel electrode 72, openings 62 formed in the pixel electrode 72, and ribs (protrusions) 61 placed on a counter electrode (not shown) facing the pixel electrode 72 via the liquid crystal layer. The ribs 61 have a stripe shape having a constant width W1 as in the MVA LCD of the embodiment described above. Each opening 62 has a stripe-shaped trunk 62a and branches 62b extending in the direction orthogonal to the extension of the trunk 62a. The stripe-shaped ribs 61 and the stripe-shaped trunks 62a are placed in parallel with each other, defining liquid crystal regions having a width W3 therebetween. The branches 62b of the openings 62 extend in the direction of the width of the liquid crystal regions, and thus each opening 62 has a comb shape as a whole as is viewed from top. As described in Japanese Laid-Open Patent Publication No. 2002-107730, with the comb-shaped openings 62, the proportion of liquid crystal molecules exposed to a tilt electric field increases, and thus the response characteristic can be improved. However, since the distribution of the response speed of liquid crystal molecules is uniquely affected by the distance between the rib 61 and the trunk 62a of the opening 62, the second LC portion low in response speed described above is formed between the opening 62 and the trunk 62a of the opening 62 irrespective of the existence of the branches 62b of the opening 62.

Accordingly, in the MVA LCD having the pixel 300a, also, the effect described above can be obtained by setting the width W3 as in the LCD of the embodiment described above.

The LCDs of the present invention can suppress alignment deflection, and thus can adopt the OS driving favorably. By adopting the OS driving, excellent moving image display characteristics can be exhibited. Accordingly, by further having a circuit for receiving television broadcast, the LCDs can be used as liquid crystal TV sets permitting high-quality moving image display. To achieve the OS driving, known methods can be broadly used. A drive circuit that permits application of an OS voltage higher than a grayscale voltage predetermined for a given grayscale level (or the grayscale voltage itself can be applied) may be additionally provided. Otherwise, the OS driving may be executed by software. The OS voltage is typically set so that the display luminance reaches a predetermined value corresponding to the target grayscale level within the time corresponding to one vertical scanning period.

According to the present invention, an alignment-divided vertical alignment LCD permitting high-quality moving image display and a driving method therefor are provided. The LCD of the present invention is suitably used as a liquid crystal TV set provided with a circuit for receiving television broadcast, for example. The LCD is also suitably applied to electronic equipment such as personal computers and PDAs used for displaying moving images.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This non-provisional application claims priority under 35 USC § 119(a) on Patent Application No. 2004-108421 filed in Japan on Mar. 31, 2004, the entire contents of which are hereby incorporated by reference.

1. A liquid crystal display device having a plurality of pixels each having a first electrode, a second electrode facing the first electrode, and a vertically aligned liquid crystal layer placed between the first and second electrodes, the device comprising:
a stripe-shaped rib having a first width placed in the first electrode side of the liquid crystal layer;
a stripe-shaped slit having a second width placed in the second electrode side of the liquid crystal layer; and
a stripe-shaped liquid crystal region having a third width defined between the rib and the slit,
wherein the third width is in a range between 2 μm and 15 μm.

2. The liquid crystal display device of claim 1, wherein the third width is 13.5 μm or less.

3. The liquid crystal display device of claim 1, further comprising a pair of polarizing plates placed to face each other with the liquid crystal layer therebetween, transmission axes of the pair of polarizing plates are orthogonal to each other, one of the transmission axes extends in a horizontal direction in the display plane, and the rib and the slit are placed to extend in a direction about 45° from the one of the transmission axes.

4. The liquid crystal display device of claim 1, wherein the magnitude of the voltage corresponding to the highest grayscale level is 7V or more.

5. The liquid crystal display device of claim 1, wherein the magnitude of the voltage corresponding to the lowest grayscale level is 0.5V or less.

6. A liquid crystal display device having a plurality of pixels each having a first electrode, a second electrode facing the first electrode, and a vertically aligned liquid crystal layer placed between the first and second electrodes, the device comprising:
a stripe-shaped first slit having a first width placed in the first electrode;
a stripe-shaped second slit having a second width placed in the second electrode; and
a stripe-shaped liquid crystal region having a third width defined between the first and second slits,
wherein the third width is in a range between 2 μm and 15 μm.

7. The liquid crystal display device of claim 6, wherein the third width is 14.2 μm or less.

8. The liquid crystal display device of claim 6, further comprising a pair of polarizing plates placed to face each other with the liquid crystal layer therebetween, transmission axes of the pair of polarizing plates are orthogonal to each other, one of the transmission axes extends in a horizontal direction in the display plane, and the first and second slits are formed to extend in a direction about 45° from the one of the transmission axes.

9. The liquid crystal display device of claim 6, wherein the magnitude of the voltage corresponding to the highest grayscale level is 7V or more.

10. The liquid crystal display device of claim 6, wherein the magnitude of the voltage corresponding to the lowest grayscale level is 1.6V or less.

11. A liquid crystal display device having a plurality of pixels each having a first electrode, a second electrode facing the first electrode, and a vertically aligned liquid crystal layer placed between the first and second electrodes, the device comprising:
stripe-shaped first alignment regulating means having a first width placed in the first electrode side of the liquid crystal layer;
stripe-shaped second alignment regulating means having a second width placed in the second electrode side of the liquid crystal layer; and
a stripe-shaped liquid crystal region having a third width defined between the first and second alignment regulating means,
wherein the third width is in a range between 2 μm and 15 μm.

12. A liquid crystal display device comprising a liquid crystal panel having a plurality of pixels each having a first electrode, a second electrode facing the first electrode, and a vertically aligned liquid crystal layer placed between the first and second electrodes, the device comprising:
stripe-shaped first alignment regulating means having a first width placed in the first electrode side of the liquid crystal layer;
stripe-shaped second alignment regulating means having a second width placed in the second electrode side of the liquid crystal layer; and
a stripe-shaped liquid crystal region having a third width defined between the first and second alignment regulating means,
wherein the liquid crystal region has a first liquid crystal portion adjacent to the first alignment regulating means, a second liquid crystal portion adjacent to the second alignment regulating means, and a third liquid crystal portion defined between the first and second liquid crystal portions, the third liquid crystal portion having a response speed lower than the response speeds of the first and second liquid crystal portions, and
the third width is set at a predetermined value or less so that the transmittance obtained when the time corresponding to one vertical scanning period has passed after application of a voltage corresponding to the highest grayscale level in the black display state can be 75% or more of the transmittance in the highest grayscale display state at a panel temperature of 5° C.

13. The liquid crystal display device of claim 12, wherein the first alignment regulating means is a rib and the second alignment regulating means is a slit formed in the second electrode.

14. The liquid crystal display device of claim 12, wherein the first alignment regulating means is a slit formed in the first electrode and the second alignment regulating means is a slit formed in the second electrode.

15. The liquid crystal display device of claim 12, further comprising a pair of polarizing plates placed to face each other with the liquid crystal layer therebetween, transmission axes of the pair of polarizing plates are orthogonal to each other, one of the transmission axes extends in a horizontal direction in the display plane, and the first and second alignment regulating means are placed to extend in a direction about 45° from the one of the transmission axes.

16. The liquid crystal display device of claim 1, wherein the first width is in a range between 4 μm and 20 μm, and the second width is in a range between 4 μm and 20 μm.

17. The liquid crystal display device of claim 1, wherein the thickness of the liquid crystal layer is 3.2 μm or less.

18. The liquid crystal display device of claim 1, wherein the first electrode is a counter electrode, and the second electrode is a pixel electrode.

19. The liquid crystal display device of claim 1, further comprising a drive circuit capable of applying an overshoot voltage higher than a grayscale voltage predetermined for a given grayscale level in grayscale display.

20. A driving method for the liquid crystal display device of claim 1, comprising the step of applying an overshoot voltage higher than a grayscale voltage predetermined for a given grayscale level in display of the given grayscale level, the given grayscale level being higher than a grayscale level displayed in the preceding vertical scanning period.

21. The driving method of claim 20, wherein the overshoot voltage is set so that the display luminance reaches a given luminance value for the given grayscale level within a time corresponding to one vertical scanning period.

22. Electronic equipment comprising the liquid crystal display device of claim 1.

23. The electronic equipment of claim 22, further comprising a circuit for receiving television broadcast.

24. Electronic equipment comprising the liquid crystal display device of claim 6.

25. The electronic equipment of claim 24, further comprising a circuit for receiving television broadcast.

26. Electronic equipment comprising the liquid crystal display device of claim 12.

27. The electronic equipment of claim 26, further comprising a circuit for receiving television broadcast.
